(19) United States
(12) Patent Application Publication
(10) Pub. No.: US 2026/0277695 A1
(43) Pub. Date: Sep. 17, 2026

(54) AGENTIC ARTIFICIAL INTELLIGENCE SYSTEMS

(71) Applicant: Roku, Inc., San Jose, CA (US)

(72) Inventor: Ritwick Babbar, Fremont, CA (US)

(21) Appl. No.: 19/076,992

(22) Filed: Mar. 11, 2025

(51) Int. Cl. G06F 9/50; G06F 11/34; G06N 3/0455

(52) U.S. Cl. CPC G06F 9/5055; G06F 11/3495; G06N 3/0455

(57) ABSTRACT

System, apparatus, article of manufacture, method and/or computer program embodiments are provided for using an agentic artificial intelligence (AI) system to automate jobs. An example method can include determining a domain of a task; assigning, by a coordinator agent including an AI model(s), the task to a domain-specific agent selected from a set of domain-specific agents based on the domain of the task and respective domains of the set of domain-specific agents, wherein each of the set of domain-specific agents comprises a different AI model trained or customized for a specific domain from the respective domains; triggering the domain-specific agent to perform the task and generate an output; and determining, by a verifier agent, an accuracy of the output generated by the domain-specific agent, wherein the verifier agent comprises another AI model(s) trained or customized to determine respective accuracies of outputs generated by the set of domain-specific agents.

### BACKGROUND

### Field

This disclosure is generally directed to agentic artificial intelligence computer systems. For example, aspects of the present disclosure relate to systems and techniques for using agentic artificial intelligence systems to automate jobs.

### SUMMARY

Provided herein are system, apparatus, article of manufacture, method and/or computer program product embodiments (and/or combinations and/or sub-combinations thereof) for implementing agentic artificial intelligence (AI) systems. In some aspects, a method is provided for using an agentic AI system to automate jobs (e.g., tasks, workflows, decisions, outputs, functions, steps, actions, operations, etc.). An example method can include determining a domain of a computer task selected for automation, and assigning, by a coordinator agent including an artificial intelligence (AI) model, the computer task to a domain-specific agent selected by the coordinator agent from a set of domain-specific agents based on the domain of the computer task and respective domains of the set of domain-specific agents. In some aspects, each of the set of domain-specific agents can include a different AI model trained or customized for a specific domain from the respective domains. The method can also include triggering the domain-specific agent to perform the computer task and generate an associated output and determining, by a verifier agent, an accuracy of the associated output generated by the domain-specific agent. The verifier agent can include another AI model trained or customized to determine accuracies of outputs generated by the set of domain-specific agents.

In some aspects, a system is provided for implementing an agentic AI system to automate jobs. The system can include one or more computing and/or media devices such as, for example, a server, a datacenter, a cloud computing system, a computer (e.g., laptop computer, desktop computer, tablet computer, etc.), a television, a media player, a set-top box, an Internet-of-Things (IoT) device, a mobile device (e.g., a smartphone, etc.), a wearable computing device (e.g., a smartwatch, smartglasses, a head-mounted display (HMD), extended reality (e.g., virtual reality, augmented reality, mixed reality, virtual reality with video passthrough, etc.) glasses, etc.), a single-board computer (SBC) or system-on-chip (SoC) device, a gaming system, and/or any computing device.

The system can include memory used to store data, such as instructions executable by one or more processors, and one or more processors coupled to the memory and configured to perform operations including determining a domain of a computer task selected for automation, and assigning, by a coordinator agent including an artificial intelligence (AI) model, the computer task to a domain-specific agent selected by the coordinator agent from a set of domain-specific agents based on the domain of the computer task and respective domains of the set of domain-specific agents. In some aspects, each of the set of domain-specific agents can include a different AI model trained or customized for a specific domain from the respective domains. The operations can also include triggering the domain-specific agent to perform the computer task and generate an associated output and determining, by a verifier agent, an accuracy of the associated output generated by the domain-specific agent. The verifier agent can include another AI model trained or customized to determine accuracies of outputs generated by the set of domain-specific agents.

In some aspects, a non-transitory computer-readable medium is provided for implementing an agentic AI system to automate jobs. In some cases, the non-transitory computer-readable medium can have instructions stored thereon that, when executed by one or more processors, cause the one or more processors to perform operations including determining a domain of a computer task selected for automation, and assigning, by a coordinator agent including an artificial intelligence (AI) model, the computer task to a domain-specific agent selected by the coordinator agent from a set of domain-specific agents based on the domain of the computer task and respective domains of the set of domain-specific agents. In some aspects, each of the set of domain-specific agents can include a different AI model trained or customized for a specific domain from the respective domains. The operations can also include triggering the domain-specific agent to perform the computer task and generate an associated output and determining, by a verifier agent, an accuracy of the associated output generated by the domain-specific agent. The verifier agent can include another AI model trained or customized to determine accuracies of outputs generated by the set of domain-specific agents.

### BRIEF DESCRIPTION OF THE FIGURES

The accompanying drawings are incorporated herein and form a part of the specification.

FIG. 1 is a block diagram illustrating an example multimedia environment, according to some examples of the present disclosure.

FIG. 2 is a block diagram illustrating an example media device, according to some examples of the present disclosure.

FIG. 3 is a diagram illustrating an example architecture of an example agentic artificial intelligence system, according to some examples of the present disclosure.

FIG. 4 illustrates an example system process for using an agentic artificial intelligence system to automate jobs, according to some examples of the present disclosure.

FIG. 5A illustrates an example training process for training a coordinator artificial intelligence agent used to route jobs to domain-specific artificial intelligence agents, according to some examples of the present disclosure.

FIG. 5B illustrates an example training process for training a domain-specific artificial intelligence agent used to perform domain-specific jobs, according to some examples of the present disclosure.

FIG. 5C illustrates an example training process for training a verifier artificial intelligence agent used to perform validation checks, according to some examples of the present disclosure.

FIG. 6 is a flowchart illustrating an example method for using the agentic artificial intelligence system to automate jobs, according to some examples of the present disclosure.

FIG. 7 is a flowchart illustrating an example method for routing jobs to domain-specific artificial intelligence agents for automation, according to some examples of the present disclosure.

FIG. 8 is a flowchart illustrating an example method for using an agentic artificial intelligence system to automate jobs, according to some examples of the present disclosure.

FIG. 9A is a diagram illustrating an example architecture of an example neural network, according to some examples of the present disclosure.

FIG. 9B is a diagram illustrating another example architecture that can be used to implement a transformer or large language model, according to some examples of the present disclosure.

FIG. 10 illustrates an example computer system that can be used for implementing various aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

Organizations, such as businesses and government entities, typically have complex tasks and workflows performed by humans (or with the assistance of humans). However, humans have significant limitations on the amount of information they can process, the speed in which they can process information, and the tasks they are capable of performing. As a result, some of the tasks and/or workflows of an organization may be too complex and/or unfeasible for humans. Some tasks and/or workflows may even be outside of the capabilities of humans. Indeed, even tasks and/or workflows that humans are able to perform may be economically and/or temporally unfeasible for humans to perform. For example, a media content platform may manage a large catalog of media content items. The catalog of media content items may need to be reviewed for quality and corrections before making such media content items available to the public (e.g., customers of the media content platform). However, in many cases, it may be very expensive and even unfeasible to have humans review the entire catalog of media content items for quality and correct any issues detected in the media content items.

To illustrate, assume that a media content platform receives a catalog of thousands of media content items that the media content platform intends to release to its customers. Before releasing the catalog of media content items to customers, the media content platform may need the media content items to be checked for quality and other issues. For example, the metadata, artwork, content, categories, and/or other attributes of the media content items may need to be checked for accuracy before releasing the media content items to customers for access via the media content platform. However, the process of checking the entire catalog of media content items for the various possible errors and issues may be costly and extremely onerous for humans to perform. Even if the entire catalog of media content items can be checked by humans as needed, the delays in performing and completing some checks may be costly or even unacceptable.

Artificial intelligence (AI) and machine learning (ML) models, such as large language models (LLMs), have remarkable abilities to efficiently process and understand complex knowledge domains and automate tasks. The AI models can be trained on large datasets to understand the complex knowledge domains and often have a degree of problem-solving skills. Moreover, the AI models may implement numerous parameters that are finetuned through training to allow the AI models to accurately parse and analyze vast amounts of information, establish connections between different concepts and information, and provide reasoned responses. The AI models can process more information than humans (and even other software algorithms) and can process information more efficiently than humans. For example, an AI model is capable of processing a large volume of information that may be otherwise unfeasible for humans to process, and can use the information to generate results accurately and efficiently.

Consequently, the AI models can be effective tools for processing large amounts of information and generating accurate, reasoned responses. For example, given an LLM's ability to evaluate a large amount of information, understand relevant principles, and generate intelligent outputs based on a wide breadth of knowledge, the LLM can effectively process a large amount of information to perform complex tasks and augment the capabilities of a computer. Moreover, an AI model, such as an LLM, can perform routine analysis and operations, propose and/or implement accurate solutions, and remove humans from the loop/process to allow the humans to focus on other problems that may be more suitable for a human. However, in some cases, the automation and/or decision-making process of an AI model may not be fully deterministic and may rely on the judgment of a human operator(s). Consequently, certain processes, tasks, and/or decisions can be challenging to automate using AI models.

Provided herein are system, apparatus, device, method (also referred to as a process) and/or computer program product embodiments, combinations and/or sub-combinations thereof (also referred to as “systems and techniques” hereinafter) for agentic AI systems that can automate tasks, workflows, operations, processes, decisions, and/or any other jobs. In some cases, the agentic AI systems described herein can include AI agents trained to automate jobs (e.g., tasks, functions, operations, actions, decisions, workflows, etc.) without human intervention, improve workflows and associated outputs, and provide increased processing and automation efficiencies. The AI agents can be powerful tools for automating jobs, making decisions, intelligently solving problems and selecting specific courses of action, and generating accurate outputs (e.g., responses, etc.). To illustrate, in the previous example of a media content platform that manages a large catalog of media content items, the AI agents of the agentic AI system described herein can check the catalog of media content items for quality, automatically manage the catalog of media content items, and even optimize any workflow and/or task used to process and/or maintain the catalog of media content items.

In some cases, the agentic AI system can implement domain-specific AI agents trained to have expertise and/or capabilities tailored to different, respective domains. The domain-specific AI agents can accurately and/or efficiently perform jobs (e.g., tasks, operations, functions, workflows, actions, decisions, etc.) in their respective domains, understand information and/or principles in their respective domains, process data in their respective domains, and/or generate outputs (e.g., responses, decisions, answers, etc.) for jobs and/or data associated with their respective domains. For example, a domain-specific AI agent can be trained to perform text processing and natural language processing (NLP), and another domain-specific AI agent can be trained to perform image processing. In this example, the domain-specific AI agent trained to perform text processing and NLP can leverage its capabilities to automate text processing and NLP tasks, and the domain-specific AI agent trained to perform image processing can leverage its image processing capabilities to automate image processing tasks.

In some cases, the agentic AI system can include an AI agent trained to operate as a coordinator that routes tasks to selected domain-specific AI agents with domain-specific knowledge and/or capabilities suitable for such tasks. To illustrate, in the previous example, the coordinator can route text processing tasks to the domain-specific AI agent trained to perform text processing and NLP, and image processing tasks to the domain-specific AI agent trained to perform image processing. This way, the coordinator can intelligently leverage AI agents trained and tailored for specific domains (e.g., trained for tasks, capabilities, operations, functions, decisions, workflows, actions, etc., in the specific domains) to perform jobs (e.g., tasks, operations, actions, workflows, decisions, functions, etc.) and/or process data associated with the specific domains, rather than using a general AI agent to perform jobs and process information across a large number of different domains. The domain-specific AI agents can provide more accurate results when performing jobs in their respective domains than a more general AI agent, and may do so more efficiently than the more general AI agent. The coordinator can be trained to associate different domain-specific AI agents with their respective domains and understand which domain-specific AI agents are more suitable for jobs and/or information in respective domains in order to route jobs and/or information to such domain-specific AI agents.

In some examples, the coordinator can be trained to understand an entity's operations, workflows, business, tasks, processing pipelines, requirements, data, systems, information, and/or any other information about or from the entity. The coordinator can use such information to make better decisions when selecting domain-specific AI agents for specific jobs (e.g., tasks, operations, functions, workflows, actions, decisions, data processing, etc.). For example, the coordinator can be trained to have a broader and/or end-to-end understanding of an entity, its business, its structure, its functions, its goals, its workflows, its tasks, its obligations, its domains, its operations, its functions, its data, its systems, and/or any other details of the entity. This knowledge/information can help the coordinator decide which domain-specific AI agent from a set of domain-specific AI agents to select for a job (e.g., task, workflow, operation, function, action, etc.). The coordinator can then route the job to the selected domain-specific AI agent.

In some cases, the agentic AI system can include one or more verifiers used to verify or validate results generated by the domain-specific AI agents. The one or more verifiers can include one or more AI agents trained to check outputs generated by the domain-specific AI agents to reduce or prevent inaccuracies, hallucinations, errors, etc. For example, if a domain-specific AI agent trained to check the metadata of media content items finds errors in the metadata, the one or more verifiers can check the errors identified by the domain-specific AI agent to validate the errors, fix the errors, or reject the errors. In some examples, rather than checking the entire set of metadata processed by the domain-specific AI agent, the one or more verifiers can perform a more narrow or nuanced check by focusing on any errors in the metadata identified by the domain-specific AI agent. By limiting the scope of the validation checks of the one or more verifiers to the outputs generated by the domain-specific AI agent (and any other outputs from any other domain-specific AI agent), the one or more verifiers can provide a more focused validation check and reduce or prevent potential errors, inaccuracies, hallucinations, etc.

The agentic AI system can automate various jobs (e.g., tasks, operations, functions, workflows, decisions, actions, etc.) and process a variety of content, understand a wide range of domains through domain-specific AI agents, etc. For example, the coordinator of the agentic AI system can use a domain-specific AI agent(s) to validate a list of media content items (e.g., movies, TV shows, video games, videos, etc.) provided by a content partner(s) to a media content platform associated with the agentic AI system. In some cases, the domain-specific AI agent(s) can validate the list of media content items against a legal document defining a legal agreement between the media content platform and the content partner(s). For example, the media content platform associated with the agentic AI system may obtain a legal document that defines the obligations of the media content platform and the content partner(s) as part of a legal agreement between the media content platform and the content partner(s), and may contain legal clauses and a list of media content items to be provided by the content partner(s) under the legal agreement. The legal document can optionally include other details such as where (e.g., in what regions) and when the media content platform may show, publish, and/or provide (e.g., make available) any of the media content items in the list.

While manually checking the legal document (including the list of media content items in the legal document) may be expensive, time consuming, and even unfeasible, a domain-specific AI agent(s) trained to understand legal documents and validate lists of media content items included in legal documents can be selected by the coordinator to parse a legal document to determine what media content items a content partner(s) has agreed to deliver to a media content platform associated with the agentic AI system, and use such information from the legal document to verify that the media content items received by the media content platform from the content partner(s) is accurate and consistent with the obligations of the content partner(s) specified in the legal document. Thus, the domain-specific AI agent can validate the accuracy of the delivery of media content items by the content partner(s) and whether the delivery complies with any relevant requirements defined in the legal document. The domain-specific AI agent can include one or more AI agents with domain-specific capabilities, such as capabilities for understanding/processing legal documents and verifying the accuracy of media content items delivered by content partners based on the legal documents. For example, the domain-specific AI agent can include an AI agent trained and customized to process/understand legal documents (e.g., an AI agent with expertise in processing/understanding legal documents) and check whether the media content items delivered by content partners are consistent with the media content items specified in legal agreements between the content partners and the media content platform that define what media content items the content partners have agreed to deliver.

An AI verifier can receive the results from the domain-specific AI agent and determine whether to validate the results. For example, the AI verifier can check any errors found by the domain-specific AI agent to determine whether the errors were accurately identified or mistakenly identified (e.g., false positives). In some cases, the AI verifier can focus on the errors found by the domain-specific AI agent rather than performing a comprehensive check of all the media content items in the list. Such focused or nuanced check can allow the AI verifier to increase the accuracy of the checks performed by the AI verifier, and thus the results from the domain-specific AI agent. In other cases, the AI verifier can check the media content items delivered and determine whether the media content items delivered match the list of media content items defined in a legal agreement between a provider and recipient of the media content items, and compare its results with the results from the domain-specific agent.

In another example, a domain-specific AI agent trained to validate the metadata of the media content items delivered by a content partner(s) can be selected by the coordinator to validate the accuracy of the metadata. For example, in some cases, when a media content platform receives media content items and associated metadata from a content provider, the media content platform may implement a content pipeline that includes quality control (QC) checks used to verify that the metadata does not contain errors. Non-limiting examples of errors in metadata associated with media content items can include an incorrect release year, an incorrect cast of a movie or TV show, an incorrect country of origin of a media content item, an incorrect title of a media content item, etc. To reduce or prevent such errors, a domain-specific AI agent can be trained and configured to check the accuracy of the metadata received from any content partner, detect errors in the metadata (if any) or confirm the accuracy of the metadata, and optionally fix or recommend how to fix any errors in the metadata (if any). In some cases, the domain-specific AI agent can collect information from one or more data sources used to verify the metadata. For example, the domain-specific AI agent can obtain media content metadata from an internal data store and/or an external source (e.g., the Internet, a database such as the Internet Movie Database (IMDB), etc.), and compare the media content metadata from the internal data store and/or external source with the metadata delivered by a content partner to determine the accuracy of the metadata from the content partner, and optionally fix or recommend how to fix any error in the metadata from the content partner (if any). An AI verifier can check the results from the domain-specific AI agent to determine whether the results from the metadata check performed by the domain-specific AI agent are accurate.

In some examples, the coordinator can select a domain-specific AI agent to detect and/or fix any errors in a content pipeline of the media content platform. For example, the media content platform can include a complex content pipeline where various systems, tasks, and/or services (e.g., microservices, service chains, service containers, etc.) are managed by different teams. Before releasing a media content item on the media content platform, the media content platform may process the media content item through various stages of the content pipeline. If the media content item is successfully processed through the various stages and results in a correct status at each stage along the content pipeline, the media content platform may release the media content item. Otherwise, if there are any errors along the content pipeline, the media content item may be rejected, the release of the media content item may be delayed, and/or the media content item may not complete content pipeline. For example, the media content item may fail a stage (or become stuck) along the content pipeline, which may need to be addressed through manual intervention. The content pipeline may be too complex for a human operator to fully understand and may require extensive user training to prepare any human operator to perform tasks in the content pipeline.

However, the agentic AI system can include one or more domain-specific AI agents trained to automate the content pipeline and/or check the content pipeline for errors (and optionally fix any errors found or suggest how to fix any errors found). In some cases, a set of domain-specific AI agents trained to check a content pipeline for errors may collaborate with each other to ensure any problems in the content pipeline and/or any errors along the content pipeline are properly identified and fixed. For example, one or more domain-specific AI agents can be trained to identify any errors in the content pipeline and fix the errors by making changes to the content processed in the content pipeline and/or changing the configuration of any systems and/or services associated with the content pipeline. The one or more domain-specific AI agents can automate such tasks without the need for a human operator to intervene. An AI verifier can check the results and/or fixes from the domain-specific AI agents to avoid inaccuracies.

In some aspects, the coordinator can select a domain-specific AI agent(s) to monitor the health of any systems of the media content platform. For example, in some cases, the media content platform can include dashboards for various components, such as service and/or workflow components, which help human operators to monitor the health of a system. The system can be configured to generate alerts to notify operators when a problem/error occurs. Typically, the remediation actions to correct such problems/errors are human dependent and may take extensive user training to allow human operators to gain the knowledge needed to fix (or determine whether they can ignore) such problems/errors. However, a domain-specific AI agent(s) can be trained to implement such remediations and thus reduce or prevent human intervention, which can reduce or avoid costs and time in training human operators to otherwise address such problems/errors.

In some aspects, the coordinator can select a domain-specific AI agent(s) to perform data deduplication. The domain-specific AI agent(s) can be trained to perform data deduplication. For example, the media content platform can receive content from various content providers and act as a content aggregator. In some cases, the media content platform may receive the same media content item/title from multiple content providers. In such cases, the media content platform may need to perform content deduplication to remove any media content item/title duplicates. In some cases, heuristics can be used to assist in content deduplication. However, as described herein, a domain-specific AI agent(s) can instead be trained to perform content deduplication. The domain-specific AI agent(s) can be selected by the coordinator to perform content deduplication as needed. The domain-specific AI agent(s) can perform content deduplication operations routed to the domain-specific AI agent(s) by the coordinator, and can optionally collect data from one or more sources to assist the domain-specific AI agent(s) with such content deduplication operations. For example, the domain-specific AI agent(s) can collect content information from an internal database and/or an external source (e.g., the Internet, IMDB, etc.) and use such information to deduplicate multiple copies of a content item received from multiple content providers (or a same content provider). An AI verifier can then check the data deduplication results from the domain-specific AI agent(s) to determine whether to the data deduplication results are accurate.

In some aspects, the coordinator can select a domain-specific AI agent to optimize a content recommendations engine for improved recommendations. For example, assume that the media content platform performs A/B testing on one or more AI/ML models used to target and/or recommend content to/for specific users. A domain-specific AI agent can be trained to identify adjustments/optimizations to the one or more AI/ML models to improve their content targeting/recommendations performance. In some cases, the domain-specific AI model can identify adjustments (e.g., parameter and/or configuration adjustments) to the one or more AI/ML models used to improve the targeting/recommendation results of the one or more AI/ML models. The domain-specific AI agent can be trained to identify adjustments to the one or more AI/ML models, and determine which adjustments to apply to the one or more AI/ML models to improve the performance of the one or more AI/ML models. In some cases, the domain-specific AI model can implement a fast, iterative approach where the domain-specific AI model continues to identify (or look for) and efficiently apply adjustments/improvements to the one or more AI/ML models predicted or estimated to improve a take rate of customers/consumers. The iterative approach of the domain-specific AI model can also fast fail adjustments/configurations that do not show or result in improvements. The fast, iterative adjustments of the one or more AI/ML models can provide continuous, incremental progress. An AI verifier can be used to check or validate adjustments identified by the domain-specific AI model before such adjustments are applied, in order to avoid or reduce errors in adjustments or adjustments based on model hallucinations.

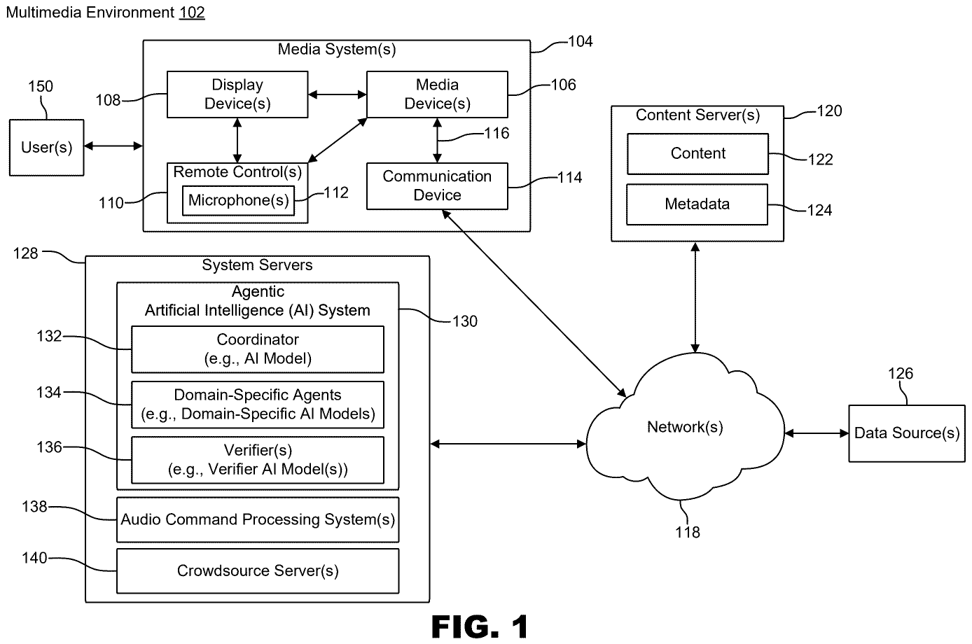

Various embodiments and aspects of this disclosure may be implemented using, and/or may be part of, multimedia environment 102 shown in FIG. 1. It is noted, however, that the multimedia environment 102 is provided for illustrative purposes and is not limiting. Examples and embodiments of this disclosure may be implemented using, and/or may be part of, environments that are different from and/or in addition to the multimedia environment 102, as will be appreciated by persons skilled in the relevant art(s) based on the teachings contained herein. An example of the multimedia environment 102 shall now be described.

### Example Multimedia Environment

FIG. 1 illustrates a block diagram of a multimedia environment 102, according to some examples of the present disclosure. In a non-limiting example, multimedia environment 102 may be directed to media content, such as streaming media. However, this disclosure is applicable to any type of media (instead of or in addition to media content), as well as any mechanism, means, protocol, method and/or process for distributing and/or processing media content.

The multimedia environment 102 may include a media system(s) 104. The media system(s) 104 can include one or more media systems, and each media system can include and/or represent a geographic area such as, for example, a family room, a kitchen, a backyard, a home theater, a school classroom, a library, a car, a boat, a bus, a plane, a movie theater, a stadium, an auditorium, a park, a bar, a conference room, a home, an entertainment room, a restaurant, an office, or any other location or space where it is desired to receive and play media content, such as streaming content. A user(s) 150 may operate the media system(s) 104 to select and consume content. The user(s) 150 can include or represent one or more users in multimedia environment 102.

The media system(s) 104 may include a media device(s) 106. The media device(s) 106 can be coupled to a display device(s) 108. The media device(s) 106 can include one or more media devices and the display device(s) can include one or more media devices. Each media device can be coupled to a display device (or multiple display devices) from the one or more display devices. It is noted that terms such as “coupled,” “connected to,” “attached,” “linked,” “combined” and similar terms may refer to physical, electrical, magnetic, logical, etc., connections, unless otherwise specified herein.

The media device(s) 106 may be or include one or more computer devices (e.g., laptop computer, desktop computer, tablet computer, etc.), streaming media devices, mobile phones (e.g., smartphones), DVDs or BLU-RAY devices, audio/video playback devices, cable boxes, gaming systems, televisions, head-mounted display (HMD) devices, set-top boxes, video display devices, smart wearable devices (e.g., smart glasses, smart watch, etc.), single-board computers (SBCs), system-on-chip (SoC) devices, and/or digital video recording devices, to name just a few non-limiting examples. Display device(s) 108 may include or be part of one or more monitors, televisions (TVs), computer devices (e.g., desktop computers, laptop computers, tablet computers, etc.), mobile phones (e.g., smartphones), wearable devices (e.g., a smartwatch, an HMD, smartglasses, etc.), screens, appliances, internet-of-things (IoT) devices, SBCs or SoCs, and/or projectors, to name just a few non-limiting examples. In some examples, the media device(s) 106 can be a part of, integrated with, operatively coupled to, and/or connected to one or more respective display devices, such as the display device(s) 108.

The media device(s) 106 may be configured to communicate with network(s) 118 via a respective communication device 114. The communication device 114 may include, for example, a cable modem, an access point, a router, a satellite TV transceiver, etc. The media device(s) 106 may communicate with the communication device 114 over a link 116. The link 116 may include wireless (e.g., WiFi, etc.) and/or wired connections.

The network(s) 118 can include one or more networks. In some examples, the network(s) 118 can include, without limitation, a wired and/or wireless intranet, an extranet, a wide-area network (WAN), a local area network (LAN), a cloud network, an Internet Service Provider (ISP) network, the Internet, a cellular network, a Bluetooth network, an infrared network, and/or any other short range, long range, local, regional, global communications mechanism, means, approach, protocol and/or network, as well as any combination(s) thereof.

Media system(s) 104 may include a remote control(s) 110. The remote control(s) 110 can be or include any component, part, apparatus and/or method for controlling the media device(s) 106 and/or display device(s) 108, such as a remote control, a tablet, laptop computer, mobile phone (e.g., smartphone), wearable, on-screen controls, integrated control buttons, audio controls, or any combination thereof, to name just a few examples. In some examples, the remote control(s) 110 can wirelessly communicate with the media device(s) 106 and/or display device(s) 108 using cellular, Bluetooth, infrared, WIFI, WIFI direct, etc., or any combination thereof. The remote control(s) 110 may include a microphone(s) 112, which is further described below.

The multimedia environment 102 may include a content server(s) 120 (also called a content provider, channel or source). Although only one content server is shown in FIG. 1, in practice, the multimedia environment 102 may include any number of content servers. The content server(s) 120 may be configured to communicate with network(s) 118.

The content server(s) 120 may store content 122 and metadata 124. Content 122 may include music, videos, movies, television (TV) programs, multimedia, images, still pictures, text, graphics, gaming applications, advertisements, programming content, public service content, government content, local community content, targeted media content, software, video games, livestreams, artwork, and/or any other content or data objects in electronic form.

In some examples, metadata 124 can include data about content 122. For example, metadata 124 may include associated or ancillary information indicating or related to writer, director, producer, composer, artist, actor, cast, title, closed captions, subtitles, tags, summary, chapters, production, history, year, trailers, alternate versions, related content, applications, and/or any other information pertaining or relating to the content 122. Metadata 124 may also or alternatively include links to any such information pertaining or relating to the content 122. Metadata 124 may also or alternatively include one or more indexes of content 122, such as but not limited to a trick mode index.

Multimedia environment 102 can include data source(s) 126. The data source(s) 126 can include one or more data sources. In some examples, the data source(s) 126 can include an internal database, a storage server, the Internet, an external database, a remote server or storage, a cloud storage system, a library, a data repository, etc. The data source(s) 126 stores and/or sources of the same and/or different types of data, such as media content, media content information, information about media content channels, metadata, media programming information (e.g., channel programming, media broadcast programming, event programming, etc.), artwork, videos, text content, files, images, software, reference data, documents, and/or any other information. In some examples, the data source(s) 126 can include information used by an agentic artificial intelligence (AI) system 130 to automate jobs (e.g., tasks, operations, workflows, decisions, outputs, actions, functions, steps, etc.) and validate or check the results from the automated jobs. The jobs can include, for example and without limitation, validating data, performing quality control (QC) checks, generating AI outputs, verifying/validating AI outputs, workflow automation, checking errors, monitoring systems, deduplicating data, validating workflows, correcting errors in processing or content pipelines, checking data accuracies, translating data, fixing errors, generating content suggestions, adjusting AI models such as content recommendation models, formulating responses, verifying and/or correcting information and/or outputs, and/or any other actions.

The multimedia environment 102 may include system servers 128. The system servers 128 may operate to support the media device(s) 106 and/or the display device(s) 108 from a remote location and/or network, such as the cloud, a backend, a datacenter, etc. It is noted that the structural and functional aspects of the system servers 128 may wholly or partially exist in the same or different ones of the system servers 128.

In some examples, the system servers 128 may include, host, operate, and/or implement the agentic AI system 130, an audio command processing system(s) 138, and/or a crowdsource server(s) 140. The agentic AI system 130 can include a coordinator 132, domain-specific agents 134, and a verifier(s) 136. The coordinator 132 can include one or more AI models trained to route jobs to domain-specific agents selected from the domain-specific agents 134. The coordinator 132 can be trained to include and/or understand the respective knowledge, expertise, and/or domains of the domain-specific agents 134; understand the operations, workflows, and/or business of an entity, platform, and/or service (e.g., a business, government entity, content platform, content service, etc.) associated with the multimedia environment 102, such as a media content platform; understand any end-to-end processes, workflows, and/or pipelines associated with the multimedia environment 102 (e.g., the media content platform, service, and/or entity); expertise across subject areas and/or domains; perform domain-specific jobs; process domain-specific data; learn about one or more domains; learn to associate domain-specific agents with specific jobs; etc. The coordinator 132 can use such information to route jobs to selected domain-specific agents from the domain-specific agents 134, as further described herein.

The domain-specific agents 134 can include AI models trained and/or optimized to have domain-specific knowledge/expertise, learn or include domain-specific capabilities, learn and perform domain-specific jobs (e.g., tasks, operations, workflows, actions, steps, functions, etc.), understand domain-specific information, understand and/or manage (e.g., monitor, adjust, configure, adapt, etc.) domain-specific aspects of systems, process domain-specific data/content, learn about respective domains, etc. Each domain-specific agent from the domain-specific agents 134 can include one or more AI models trained and/or optimized for one or more respective domains. In some examples, a domain-specific agent can include knowledge, expertise, functionalities, intelligence, capabilities, information, parameters, attributes and/or training of, for, or in a specific domain(s).

A domain can include a topic, a subject, a field, an area of knowledge, a process, a workflow, a pipeline, an operation, a functionality and/or capability, a system or type of system, a type of data, a category, a portion (e.g., stage, process, step, operation, function, task, area, field or subfield, etc.) of an end-to-end process/workflow/pipeline, a type or category of content (e.g., audio, video, text, movies, TV shows, a content genre, etc.), a category of information, an activity, a discipline, a policy, a principle, a procedure, a body of knowledge, a skill, a resource, a technology, any AI feature and/or functionality, a procedure, a capacity, an output or type of output, a processing category, and/or any knowledge, functional, or operating domain. An AI feature and/or functionality associated with a domain can include, for example and without limitation, image and/or video processing, text processing, natural language processing (NLP) and/or natural language understanding (NLU) (e.g., speech recognition, text/language translation, sentiment analysis, language modeling, acoustic modeling, etc.), segmentation, computer and/or machine vision, object detection, prediction, anomaly detection, monitoring, scene detection, content recommendation, clustering, pattern recognition or detection, facial recognition, predictive analytics, automation, quality control (QC), error detection and/or correction, data deduplication, content generation (e.g., generative AI), data processing, content pipeline error detection and/or correction, legal document understanding, content pipeline management, supply chain management, image recognition, data analysis, etc.

Non-limiting examples of domains that the domain-specific agents 134 can be trained, configured, and tailored for can include a data science domain (e.g., data modeling, data insights, workflows, business policies, etc.), a software development domain (e.g., software, user workflows, software policies, software structures, software languages, algorithms, etc.), a technical domain (e.g., a science, a system, a technology, etc.), a resource domain (e.g., a type of resource, a resource category, etc.), a functional domain, an AI domain (e.g., object detection and/or recognition, NLP and/or NLU, content matching, data deduplication, machine and/or computer vision, segmentation, generative AI, anomaly detection, prediction, content recommendation, pattern recognition, etc.), a business domain (e.g., a business department, a business area, a business function, a business category, a business pipeline, etc.), a content domain (e.g., audio content, metadata content, video content, text content, movies, TV shows, video games, image content, graphics, etc.), a system domain (e.g., hardware, software, system parameters, system operation, system services, system processing pipeline, system health, system components, system states, system profiles, system flags, etc.), an output or operational domain (e.g., decision making, QC, validation, content generation, predictive suggestions, information mapping, model or parameter optimization, training, etc.), etc.

An AI model(s) used to implement a domain-specific agent from the domain-specific agents 134 can include any type of AI model(s). For example, the AI model(s) used to implement a domain-specific agent can include a large language model (LLM), a large vision model (LVM), a large audio model (LAM), a convolutional neural network (CNN) model, a recurrent neural network (RNN) model, a transformer, an encoder and/or decoder model, an NLP model, an NLU model, an artificial neural network (ANN) model, a residual network model, a long short-term memory (LSTM) model, a generative model, a generative adversarial network (GAN) model, a generative pre-trained transformer (GPT), an autoencoder, a bidirectional encoder representations from transformers (BERT) model, a deep belief network (DBN) model, a variational autoencoder (VAE) model, a graph neural network (GNN) model, and/or any other type of AI model. In some examples, each of the domain-specific agents 134 can be trained with data associated with a respective domain, such as domain-specific sampled data, documents, articles, knowledgebase content, measurements, Internet data, business data, system data, scraped data, ground-truth data, reference data, feature or vector embeddings, text data, image data, video frames, audio data, statistical data, historical data, data logs, documentations, parameters, variables, database records, extracted data, training datasets, system outputs, model outputs, values, synthetic data, content items, and/or any other data.

The domain-specific agents 134 can be domain specific in the sense that they are trained, configured, customized, and/or optimized for respective domains. In other words, the domain-specific agents 134 can be trained as experts (e.g., with knowledge) in respective domains, configured to understand respective domains (and/or associated information), optimized for respective domains, configured to perform operations and/or make decisions associated with respective domains, finetuned for respective domains, configured to operate with data associated with respective domains, configured/trained with capabilities in the respective domains, trained to generate outputs associated with the respective domains, trained to recognize patterns associated with respective domains, trained to process data associated with the respective domains, trained with functionalities associated with the respective domains, trained to perform jobs associated with the respective domains, and/or trained with data from respective domains. In some cases, the domain-specific agents 134 can be configured to collect data that the domain-specific agents 134 can use to generate and/or validate outputs (e.g., responses, recommendations, results, decisions, determinations, actions, etc.). For example, the domain-specific agents 134 can be configured to collect data from the content server(s) 120 and/or data source(s) 126, and use the collected data to assist the domain-specific agents 134 to generate outputs and/or verify/validate outputs.

The verifier(s) 136 can include one or more AI agents. The one or more AI agents can include or can be implemented using one or more AI models such as, for example and without limitation, one or more LLMs, LVMs, LAMs, CNNs, RNNs, ANNs, NLP models, NLU models, GANs, LSTMs, GPTs, DBNs, VAEs, BERTs, GNNs, transformers, generative models, autoencoders, etc. The verifier(s) 136 can be trained to check, verify/validate, and/or determine an accuracy of outputs (e.g., results, responses, etc.) from the domain-specific agents 134. In some cases, the verifier(s) 136 can be trained to correct errors in outputs from the domain-specific agents 134 or suggest how to correct the errors. In some examples, the verifier(s) 136 can be trained to include knowledge and/or perform jobs from each of the respective domains of the domain-specific agents 134. In some cases, the verifier(s) 136 can include AI agents trained and/or customized for different domains from the respective domains of the domain-specific agents 134. In some examples, for each domain of the domain-specific agents 134, the verifier(s) 136 can include an AI verifier agent trained for that domain. For example, if the domain-specific agents 134 include a domain-specific agent trained for a language translation domain and a domain-specific agent trained for a data deduplication domain, the verifier(s) 136 can include an AI verifier agent trained for language translation and an AI verifier agent trained for data deduplication. Alternatively or additionally, the verifier(s) 136 can include an AI verifier agent trained with knowledge and capabilities across all or multiple domains from the respective domains of the domain-specific agents 134.

In some cases, the verifier(s) 136 can be trained to have a higher or broader level of understanding, expertise, capability, and/or knowledge about the multimedia environment 102, an entity (e.g., a media content platform, service, or business) associated with the agentic AI system 130, any of the respective domains of the domain-specific agents 134, data/content of the content server(s) 120 and/or system servers 128, operations of the entity, a business of the entity, an end-to-end process of the entity, a content or processing workflow(s) and/or pipeline(s) of the entity, functions of the entity, policies of the entity, customers of the entity, users of the entity, systems of the entity, data of the entity, activities of the entity, processes of the entity, a knowledgebase of the entity, outputs of the entity, etc. Moreover, the verifier(s) 136 can be configured to check (or validate) outputs from the domain-specific agents 134 for accuracy. The verifier(s) 136 can check information at a more focused and/or nuanced level than the domain-specific agents 134. For example, the verifier(s) 136 can be configured to focus on the accuracy of the outputs or portions of the outputs from the domain-specific agents 134, while the domain-specific agents 134 may, in some cases, process more data to generate such outputs. In some examples, the more focused and/or nuanced checks/operations of the verifier(s) 136 can allow the verifier(s) 136 to achieve an increased accuracy relative to the domain-specific agents 134 and/or avoid certain errors (e.g., inaccuracies, hallucinations, etc.) that the domain-specific agents 134 may potentially encounter or include in their outputs due to the broader scope of focus, information, responsibilities, processing, data, and/or outputs of the domain-specific agents 134.

The system servers 128 may also include an audio command processing system(s) 138. As noted above, the remote control(s) 110 may include a microphone(s) 112. The microphone(s) 112 may receive audio data from the user(s) 150 (as well as other sources, such as the display device(s) 108). In some examples, the media device(s) 106 may be audio responsive, and the audio data may represent verbal commands from the user(s) 150 to control the media device(s) 106 as well as other components in the media system(s) 104, such as the display device(s) 108. In some examples, the audio data received by the microphone(s) 112 in the remote control(s) 110 can be transferred to the media device(s) 106, which can forward the audio data to the audio command processing system(s) 138. The audio command processing system(s) 138 can operate to process and analyze the received audio data to recognize information or commands/speech in the audio data, such as any verbal commands/utterances of the user(s) 150. The audio command processing system(s) 138 may optionally forward the verbal commands/utterances back to the media device(s) 106 for processing.

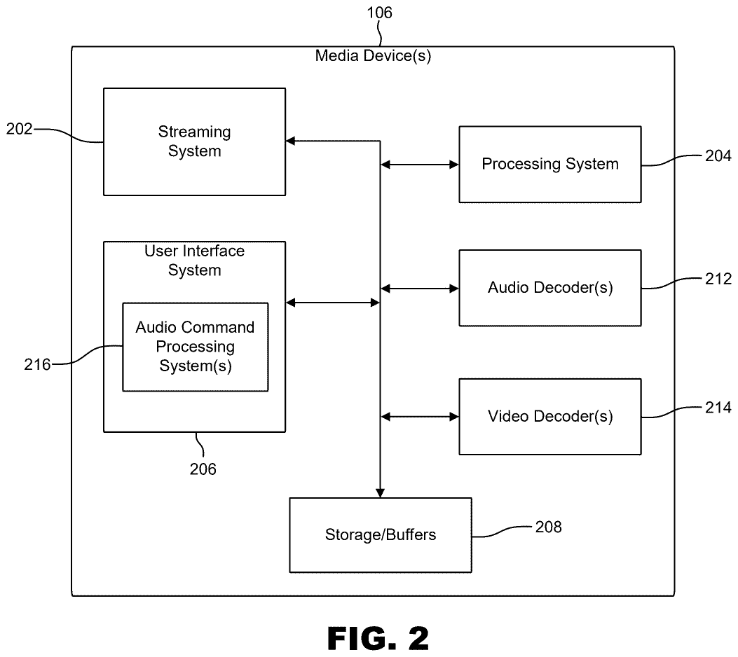

In some examples, the audio data may be alternatively or additionally processed and analyzed by an audio command processing system(s) 216 in the media device(s) 106 (see FIG. 2). The media device(s) 106 and the system servers 126 may cooperate to pick one of the verbal commands/utterances to process (either the verbal command/utterance recognized by the audio command processing system(s) 138 or the verbal command/utterance recognized by the audio command processing system(s) 216 in the media device(s) 106).

The system servers 128 can also include a crowdsource server(s) 140. The crowdsource server(s) 140 can include one or more crowdsource servers. In some examples, the crowdsource server(s) 140 can operate to cause closed captioning of a given media content item to be automatically turned on and/or off during streaming of the given media content item, such as a movie. For example, using information received from the media device(s) 106 in the media system(s) 104 (e.g., in thousands or millions of media systems), the crowdsource server(s) 140 may identify similarities and overlaps between closed captioning requests issued by different users watching a particular movie. Based on such information, the crowdsource server(s) 140 may determine that turning closed captioning on may enhance the users'viewing experience at particular portions of the movie (for example, when the soundtrack of the movie is difficult to hear), and turning closed captioning off may enhance the users'viewing experience at other portions of the movie (for example, when displaying closed captioning obstructs important or relevant visual aspects of the movie). Accordingly, the crowdsource server(s) 140 may operate to cause closed captioning to be automatically turned on and/or off during future streamings of the movie.

FIG. 2 illustrates a block diagram of an example media device, according to some examples of the present disclosure. In FIG. 2, the media device(s) 106 represents a single media device. Moreover, the media device(s) 106 in FIG. 2 may include a streaming system 202, processing system 204, user interface system 206, and storage/buffers 208. As described above, the user interface system 206 may include the audio command processing system(s) 216. In some cases, the audio command processing system(s) 216 included in the user interface system 206 in FIG. 2 can be the same as the audio command processing system(s) 138 in/from the system servers 128 in the multimedia environment 102 shown in FIG. 1. In other cases, the audio command processing system(s) 216 included in the user interface system 206 in FIG. 2 can be a version of the audio command processing system(s) 138 in/from the system servers 128 in the multimedia environment 102 shown in FIG. 1. For example, in such cases, the audio command processing system(s) 216 included in the user interface system 206 in FIG. 2 can be a local version, a client version, standalone version, and/or a lighter version (e.g., a smaller version having a smaller data size; a version with less components, features, functions, modules, libraries, and/or capabilities; a version with less code or a smaller package of code; etc.) of the audio command processing system(s) 138 in the system servers 128.

The media device(s) 106 may also include one or more audio decoders 212 and one or more video decoders 214. Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples. The media device(s) 106 can implement other applicable decoders, such as a closed caption decoder.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OP1a, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to, H.263, H.264, H.265, VVC (also referred to as H.266), AVI, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

The user interface system 206 can generate, manage, render, and/or configure a user interface to be displayed by the media device(s) 106 and/or a display device associated with the media device(s) 106, such as display device(s) 108. For example, the user interface system 206 can generate, manage, render, and/or configure a media platform interface where the user(s) 150 can access, view, search, navigate, play, control, select, and/or interact with any media content from an associated media content platform. The user interface generated, managed, rendered, and/or configured by the user interface system 206 can depict content, interface elements (e.g., input elements, navigation elements, interface objects, etc.), outputs, objects, text, images, videos, metadata, and/or any other type of content.

Now referring to both FIGS. 1 and 2, in some examples, the user(s) 150 may interact with the media device(s) 106 via, for example, the remote control(s) 110. For example, the user(s) 150 may use the remote control(s) 110 to interact with the user interface system 206 of the media device(s) 106 to select content, such as a movie, TV show, music, book, application, game, etc. The streaming system 202 of the media device(s) 106 may request the selected content from the content server(s) 120 over the network(s) 118. The content server(s) 120 may transmit the requested content to the streaming system 202. The media device(s) 106 may transmit the received content to the display device(s) 108 for playback to the user(s) 150.

In streaming examples, the streaming system 202 may transmit the content to the display device(s) 108 in real time or near real time as it receives such content from the content server(s) 120. In non-streaming examples, the media device(s) 106 may store the content received from the content server(s) 120 in storage/buffers 208 for later playback on display device(s) 108.

### Agentic AI System For Automation and Domain-Specific Jobs

Referring again to FIG. 1, the agentic AI system 130 can be used to automate jobs (e.g., tasks, workflows, operations, processes, decisions, actions, functions, outputs, workloads, etc.) using an agentic AI workflow that implements specialized AI agents to perform the jobs and a verifier AI agent to check the outputs from the specialized AI agents. For example, the agentic AI system 130 can include domain-specific AI agents trained to automate respective domain-specific jobs without human intervention, improve associated decisions and outputs, provide increased efficiencies, and obtain increased accuracies. The domain-specific AI agents can be powerful tools for automating jobs, making decisions, selecting courses of action, fixing problems/errors, generating data/content, formulating outputs and responses, etc. In some cases, the agentic AI system 130 can include a set of domain-specific AI agents trained for and/or tailored to respective domains.

The domain-specific AI agents can accurately and efficiently perform jobs with greater (and more relevant) expertise in their respective domains, understand information and/or principles in their respective domains, process data associated with their respective domains, and/or generate outputs (e.g., responses, answers, decisions, content, values, etc.) with the benefit of their domain-specific expertise and capabilities. For example, a first domain-specific AI agent can be trained to perform text processing and NLP/NLU, a second domain-specific AI agent can be trained to perform data deduplication, and a third domain-specific AI agent can be trained to perform image processing. In this example, the first domain-specific AI agent can leverage its text processing and NLP/NLU capabilities to automate text processing and NLP/NLU tasks, the second domain-specific AI agent can leverage its data deduplication capabilities to automate data deduplication tasks, and the third domain-specific AI agent can leverage its image processing capabilities to automate image processing tasks.

As further described herein, the agentic AI system 130 can include an AI agent(s) trained to operate as a coordinator(s) that routes jobs to selected domain-specific AI agents with domain-specific knowledge and/or capabilities suitable for such jobs. To illustrate, in the previous example, the coordinator(s) can route text processing and NLP/NLU jobs to the domain-specific AI agent trained to perform text processing and NLP/NLU, data deduplication jobs to the domain-specific AI agent trained to perform data deduplication, and image processing jobs to the domain-specific AI agent trained to perform image processing. Thus, the coordinator(s) can intelligently route jobs associated with specific domains to AI agents trained and tailored for such domains (e.g., trained/tailored for specific jobs/tasks, capabilities, information, responses, etc., in such domains), rather than using a general AI model/agent to perform jobs across a wide range of different domains. The domain-specific AI agents can provide more accurate results when performing jobs associated with their respective domains than a more general AI model/agent, and may do so more efficiently than the more general AI model/agent.

The coordinator(s) can route a job to the most suitable domain-specific AI agent from the various domain-specific AI agents. The coordinator(s) can route jobs to domain-specific AI agents based on the domains associated with the jobs and the respective domains of the domain-specific AI agents. The coordinator(s) can be trained to associate domain-specific AI agents with respective domains and understand which domain-specific AI agents are more suitable for jobs in specific domains. This way, the coordinator(s) can intelligently route jobs to domain-specific AI agents that are most suitable for such jobs. In some examples, the coordinator(s) can be trained to understand an entity's end-to-end processes, operations, domains, workflows, business, tasks, content, systems, requirements, preferences, context, information, attributes, environment, etc. The coordinator(s) can use such information to make better decisions when selecting domain-specific AI agents for specific jobs. For example, the coordinator(s) can be trained with a broader and/or end-to-end understanding of an entity, its business, its structure, its functions, its goals, its workflows, its tasks, its obligations, its domains, its operations/functions, its requirements, its preferences, its processes, its systems, its environment, its data, its outputs, and/or any other details of the entity. This information can assist the coordinator(s) in deciding which domain-specific AI agent should handle a job.

The agentic AI system 130 can also implement a verifier AI agent(s) trained and configured to verify/validate outputs generated by the domain-specific AI agents. The verifier(s) can determine whether to verify/validate outputs generated by the domain-specific AI agents to reduce inaccuracies, hallucinations, errors, etc. For example, if a domain-specific AI agent trained to check the metadata of media content items finds errors in the metadata, the verifier(s) can check the errors found by the domain-specific AI agent to determine whether to verify/validate the errors. In some examples, rather than checking the entire set of metadata processed by the domain-specific AI agent, the verifier(s) can perform a more focused or nuanced check by focusing on the errors found by the domain-specific AI agent. By limiting the scope of the validation checks of the verifier(s) to the results (or portions of the results) from the domain-specific AI agent (e.g., the errors in the previous example) rather than having the verifier(s) process the entire set of data (e.g., the metadata), the verifier(s) can provide a more focused validation result with a higher accuracy, and reduce potential errors or hallucinations. Consequently, the verifier(s) can reduce, prevent, or correct errors and/or hallucinations from the domain-specific AI agents.

The disclosure now continues with a further discussion of agentic AI systems for automation and domain-specific jobs.

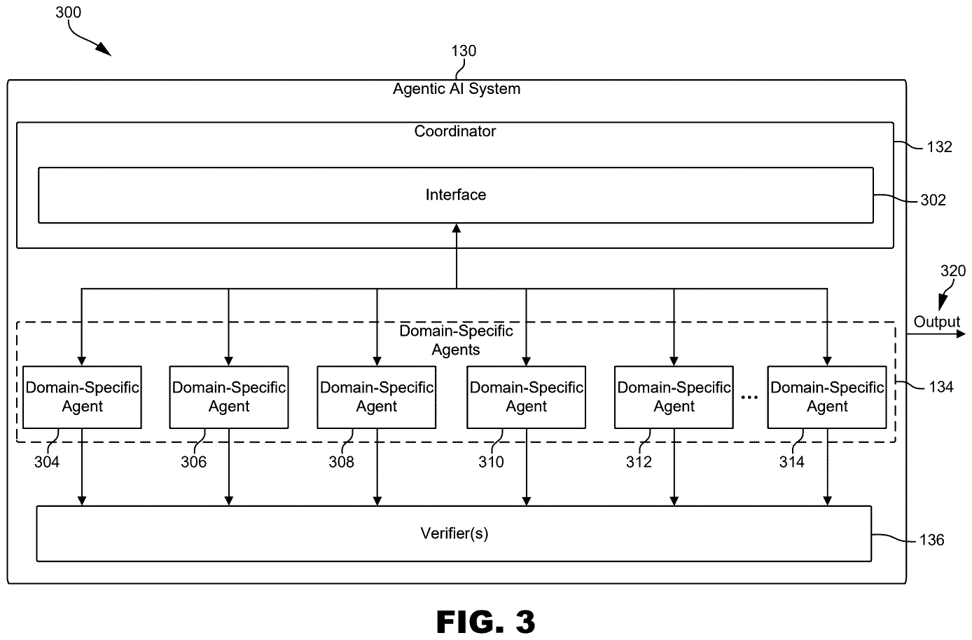

FIG. 3 is a diagram illustrating an example architecture 300 of an example agentic AI system 130, according to some examples of the present disclosure. The agentic AI system 130 can be used to perform and/or automate jobs using AI, and verify/validate the outputs from such jobs. The jobs can include, for example and without limitation, tasks, operations, functions, workflows, actions, workloads, etc. For example, the jobs can include QC checks, data duplication tasks, error correction tasks, processing pipeline checks, translation tasks, data matching tasks, data verification tasks, model optimization/finetuning operations, etc.

The example architecture 300 of the agentic AI system 130 includes a coordinator 132, domain-specific agents 134, and a verifier(s) 136. The domain-specific agents 134 can includes domain-specific agents 304-314 trained and/or optimized for different domains, such as a set of domains associated with jobs processed, to be processed, and/or expected to be processed by the agentic AI system 130.

In general, the coordinator 132 can be trained and configured to identify which of the domain-specific agents 134 may be best suited for a specific job, and route that job to that domain-specific agent(s). The job can include a task, workflow, process, function, operation, request, and/or any other job. Moreover, the coordinator 132 can include, represent, or be implemented by one or more AI/ML models. For example, the coordinator 132 can include one or more LLMs, LVMs, LAMs, CNNs, RNNs, transformer networks, autoencoders, and/or any other AI/ML model.

The coordinator 132 can be trained to intelligently determine which domain-specific agent(s) from the domain-specific agents 134 is/are most suitable for a job(s), and route the job(s) to the determined domain-specific agent(s). In some examples, the coordinator 132 can select a domain-specific agent for a job based on a knowledge domain associated with the job and the respective knowledge domains of the domain-specific agents 134 (e.g., the respective knowledge domains that the domain-specific agents 134 are trained for, tailored to, experts in, etc.). For example, the coordinator 132 can be trained to understand a domain associated with a job and understand a respective domain of each of the domain-specific agents 134, and determine which domain-specific agent(s) to route a job to based on the domain of the job and the respective domain of each of the domain-specific agents 134.

In some examples, the coordinator 132 can be trained to analyze a job and identify a domain associated with the job. For example, the coordinator 132 can be trained to determine which knowledge domain is most relevant to a job, and select a domain-specific agent from the domain-specific agents 134 for the job based on the knowledge domain that is most relevant to the job and the respective knowledge domains of the domain-specific agents 134. To illustrate, the coordinator 132 can analyze a job and determine a type of expertise that is best suited for the job (e.g., a type of expertise that can provide the most accurate results for the job, the type of expertise that can most efficiently perform the job, a type of expertise that can generate a result for the job with the highest confidence, a type of expertise that can generate the most reliable result for the job, etc.) and identify a knowledge domain of the job best on the type of expertise that is best suited for the job. The coordinator 132 can select a domain-specific agent for the job based on the knowledge domain of the job and the respective knowledge domains of the domain-specific agents 134.

In some examples, the coordinator 132 can match the domain determined for the job with the domain associated with a domain-specific agent(s), and route the job to the domain-specific agent(s) associated with the matching domain. In some cases, the coordinator 132 can compare the domain determined for the job with the respective domains of the domain-specific agents 134 to identify which domain-specific agent(s) is most suitable for the job and route the job to that domain-specific agent(s). For example, the coordinator 132 can calculate a similarity and/or distance (or similarity score and/or distance score) between the domain associated with the job and the respective domain of each of the domain-specific agents 134, and select a domain-specific agent(s) for the job based on the similarities and/or distances between the domain associated with the job and the respective domains of the domain-specific agents 134. The coordinator 132 can compare the similarities and/or distances between the domain of the job and the respective domains of the domain-specific agents 134 to identify which domain(s) from the respective domains of the domain-specific agents 134 is/are associated with the highest similarity and/or distance, and select the domain-specific agent(s) associated with that domain(s) for the job. The similarities and/or distances of the respective domains of the domain-specific agents 134 can represent or quantify a relevance, similarity, matching amount, and/or overlap of the respective domains to the domain of the job.

In some cases, the coordinator 132 can be trained to identify a domain associated with a job based on an area, topic, field, and/or attribute of the job. For example, if the job relates to text processing, the coordinator 132 can identify a text processing domain for the job. The coordinator 132 can additionally or alternatively be trained to identify a domain associated with a job based an operation, task, expertise, principle, capability, and/or feature used or needed to perform the job. To illustrate, if the job involves performing a computer vision task/operation and/or if a computer vision expertise, capability, feature, and/or principle would be used or needed to perform the job, the coordinator 132 can identify computer vision as a domain of the job.

The coordinator 132 can additionally or alternatively be trained to identify a domain associated with a job based on a type of data/information and/or content item associated with the job and/or that would or need to be processed for the job. For example, if performing the job involves processing text, the coordinator 132 can identify text processing as the domain of the job, and if the job involves processing image data, the coordinator 132 can identify image processing as a domain of the job. In this example, the coordinator 132 can then select a domain-specific agent for the text processing job that is trained for and/or associated with a text processing domain, and select another domain-specific agent for the image processing job that is trained for and/or associated with an image processing domain. As another example, if the job involves processing system logs to determine a health of a system, the coordinator 132 can identify processing system to determine a system health as a domain of the job. The coordinator 132 can then select a domain-specific agent for the job that is trained for and/or is associated with processing system logs to determine a system health.

In some examples, to configure the coordinator 132 to identify a domain of a job and/or associate a domain with the job, the coordinator 132 can be trained with data from the respective domains of the domain-specific agents 134. For example, if the domain-specific agent 304 is trained to perform translations, the domain-specific agent 306 is trained to perform quality control (QC) checks on artwork of media content items (e.g., movies, TV shows, video games, etc.), domain-specific agent 308 is trained to perform QC on metadata, domain-specific agent 310 is trained to identify and correct errors in a content pipeline, domain-specific agent 312 is trained to perform data deduplication, and domain-specific agent 314 is trained to finetune a media content recommendation engine, the coordinator 132 can be trained using training data from a translations domain, artwork domain (and/or artwork QC domain), metadata domain (and/or metadata QC domain), content pipeline domain (and/or content pipeline error identification and correction domain), data deduplication domain, and/or media content recommendations domain (and/or media content recommendation engine finetuning domain).

In some cases, the training dataset used to train the coordinator 132 can include a set of example jobs. For example, the coordinator 132 can be trained to process a set of jobs to match specific jobs with respective domain-specific agents from the domain-specific agents 134. As part of the training, parameters (e.g., weights, biases, etc.) of the coordinator 132 can be adjusted based on errors (e.g., losses) in the matching results generated by the coordinator 132 (e.g., the errors/losses in processing the jobs and matching the jobs with respective domain-specific agents) until the coordinator 132 reaches a certain accuracy, performance, and/or threshold when processing and matching jobs with respective domain-specific agents. In some cases, the coordinator 132 can also be optionally trained with information about the respective domains associated with the domain-specific agents 134. The coordinator 132 can use such information to help the coordinator 132 match jobs (and/or associated domains) with domain-specific agents (and/or associated domains) from the domain-specific agents 134.

In some cases, the coordinator 132 can optionally be trained to understand (and/or to obtain a higher-level and/or end-to-end understanding of) an entity associated with the agentic AI system 130, any workflows associated with the entity, any tasks associated with the entity, a business associated with the entity, operations associated with the entity, any aspects or details of the entity, any systems of the entity, any data and/or content items of the entity, any domains of the entity, any requirements of the entity, any constraints or rules of the entity, any features of the entity, a structure of the entity, any process of the entity, any jobs of the entity, any pipelines associated with the entity, and/or any other information and/or attributes associated with the entity. This can help the coordinator 132 have a better understanding of the entity, how to process jobs associated with the entity, and how to match jobs (and/or associated domains) with domain-specific agents (and/or associated domains).

For example, the coordinator 132 can be trained to understand each process, pipeline, workflow, operation, job, etc., of the entity. In some examples, the coordinator 132 can be trained to understand each process, pipeline, workflow, operation, job, etc., of the entity at an end-to-end level in order to better understand every stage, step, component, operation, and/or portion of each process, pipeline, workflow, operation, job, etc. In some examples, the coordinator 132 can be trained to understand each individual stage, step, component, subprocess, suboperation, subtask, and/or portion of each process, pipeline, workflow, operation, job, etc., of the entity.

In some cases, the coordinator 132 can be trained with a first dataset that includes a knowledge base of information about the entity, any workflows of the entity, any pipelines of the entity, any operations of the entity, any systems of the entity, any objects of the entity, any jobs of the entity, any processes of the entity, any parameters associated with the entity, any data of the entity, and/or any other details or information about or associated with the entity. The coordinator 132 can also be trained with a second dataset that includes information about each of the respective domains of the domain-specific agents 134. The training using the first dataset and the second dataset can be used to adjust the coordinator 132 and/or its parameters (e.g., weights, biases, etc.) to optimize the coordinator 132 to produce the most accurate results when matching jobs with domain-specific agents (e.g., matching domains of jobs with domains of domain-specific agents). In some examples, the coordinator 132 can use the first dataset and the second dataset to improve its matching results when matching jobs (e.g., associated domains) with domain-specific agents (e.g., associated domains) in order to route the jobs to the most suitable domain-specific agents.

In some cases, the coordinator 132 can include a single coordinator instance or model (e.g., AI/ML model) used to associate jobs with domains and select domain-specific agents for the jobs based on the domains associated with the domains and respective domains of the domain-specific agents 134. In other cases, the coordinator 132 can include multiple coordinator instances or models (e.g., AI/ML models) used to associate jobs with domains and select domain-specific agents for the jobs based on the domains associated with the domains and respective domains of the domain-specific agents 134. For example, the coordinator 132 can include an AI/ML model (or multiple AI/ML models) used to determine the domains associated with jobs, and an AI/ML model (or multiple AI/ML models) used to route the jobs to respective domain-specific agents based on the domains associated with the jobs and the respective domains of the domain-specific agents 134.

As previously noted, the coordinator 132 can route jobs to specific domain-specific agents from the domain-specific agents 134. The goal of the coordinator 132 can be to match jobs (and/or domains) with specific domain-specific agents that are best suited for such jobs (and/or domains), such as the domain-specific agents having the most expertise in (and/or most relevant or similar expertise to) the respective domains associated with the jobs. In some examples, the coordinator 132 can include an interface 302 used to communicate with the domain-specific agents 134. For example, the coordinator 132 can use the interface 302 to route jobs to respective domain-specific agents from the domain-specific agents 134. The coordinator 132 can optionally use the interface 302 to receive information from the domain-specific agents 134. The information from the domain-specific agents 134 can include, for example and without limitation, domain and/or expertise information, status information (e.g., bandwidth, queues, error states, availability, states, etc.), outputs, calls, preferences, routing information, responses, identifying information, configuration information, capabilities, model information, etc. In some cases, the coordinator 132 can optionally use the interface 302 to communicate with the verifier(s) 136. For example, the coordinator 132 can use the interface 302 to provide information to the verifier(s) 136 and/or receive outputs from the verifier(s) 136.

The interface 302 can include any type of interface for communicating information. For example, the interface 302 can include one or more application programming interfaces (APIs) for communicating with the domain-specific agents 134 (and optionally with the verifier(s) 136). The interface 302 can send the jobs to respective domain-specific agents from the domain-specific agents 134 (and any associated information), instructions to trigger the respective domain-specific agents to perform the jobs, and/or calls to perform the jobs.

When a domain-specific agent from the domain-specific agents 134 receives a job from the coordinator 132, the domain-specific agent can perform the job and provide an associated output to the verifier(s) 136, which can check the output as further described herein. The domain-specific agents 134 can include multiple agents trained and/or customized to perform jobs associated with different domains, such as jobs involving expertise in different domains, capabilities from different domains, information from different domains, inputs from different domains, processing attributes associated with different domains, tasks/operations from different domains, etc.

In some cases, the number and type of the domain-specific agents 134 can depend on the types of jobs to be performed using domain-specific agents and/or the expertise determined for performing such jobs. For example, if the domain-specific agents 134 are intended for use in checking lists of media content items received from one or more content providers, translating text (e.g., closed captions, metadata, etc.) in the media content items, checking a quality of artwork associated with the media content items, checking a content pipeline used to process the media content items for errors and correcting an errors found, deduplicating data associated with the media content items, and adjusting a recommendations engine used to recommend media content items to users, the domain-specific agents 134 can include respective domain-specific agents for checking lists of media content items received, translating text in the media content items, checking the quality of artwork in the media content items, checking the content pipeline for errors and correcting any errors found, deduplicating data, and adjusting the recommendations engine.

The number and type of domain-specific agents 134 can also depend on the desired level of specialization or customization of each of the domain-specific agents 134. For example, if the domain-specific agents 134 are intended for use in automating computer vision tasks, the domain-specific agents 134 can include a domain-specific agent trained and customized for computer vision. The domain-specific agent trained and customized for computer vision can be used for all computer vision jobs. Alternatively, if more narrow specialization or customization is sought, the domain-specific agents 134 can include multiple domain-specific agents trained and customized for different computer vision tasks. The different domain-specific agents can be used for their respective computer vision tasks to provide more granular computer vision expertise and customization and use the more granular computer vision expertise and customization to route computer vision jobs to corresponding domain-specific agents from the multiple domain-specific agents trained or customized for different computer vision tasks.

The domain-specific agents 134 can include any number of domain-specific agents and/or domain-specific agents for any number and/or type of domains. In some cases, the domain-specific agents 134 can be determined based on the jobs and/or domains associated with an entity and/or to be processed by the domain-specific agents 134. For example, if the domains associated with an entity or the domains associated with jobs to be processed by the agentic AI system 130 (and/or for the entity) include 10 domains, the domain-specific agents 134 can include at least 10 domain-specific agents, including a domain-specific agent for each of the 10 domains (e.g., a domain-specific agent trained for a different domain from the 10 domains). In FIG. 3, the domain-specific agents 134 include domain-specific agent 304 to 314. However, in other examples, the domain-specific agents 134 can include more or less domain-specific agents than shown in FIG. 3. One of ordinary skill in the art will recognize from the disclosure that the number of domain-specific agents shown in FIG. 3 is merely one illustrative example provided for explanation purposes.

As previously noted, when a domain-specific agent from the domain-specific agents 134 performs a job (e.g., performs a task or operation, performs a process, performs a workflow, performs a QC check, generates data, etc.), the domain-specific agent can send an output from or for the job to the verifier(s) 136. The verifier(s) 136 can receive the output and perform a validation check on the output to verify whether the output is accurate, check the output for any errors or hallucinations, correct any errors in the output, and/or increase an accuracy or confidence in the output.

The verifier(s) 136 can include one or more AI/ML models/agents trained and configured to determine whether to verify/validate outputs (e.g., results, responses, data, etc.) from the domain-specific agents 134 and optionally correct any errors in the outputs. The verifier(s) 136 can determine whether to verify/validate outputs from the domain-specific agents 134 to reduce inaccuracies, hallucinations, errors, etc. In some examples, when performing a validation check on an output of a domain-specific agent, the verifier(s) 136 can perform the job performed by the domain-specific agent and used to generate the output, and compare its output with the output from the domain-specific agent.

In other examples, when performing a validation check on an output of a domain-specific agent, rather than performing the entire job performed by the domain-specific agent when generating the output or checking the entire set of data processed by the domain-specific agent when generating the output, the verifier(s) 136 can perform a more focused or nuanced check by focusing on the output from the domain-specific agent. For example, if the output from a job performed by the domain-specific agent 304 is a list of errors found in metadata associated with a media content item, instead of checking all of the metadata processed by the domain-specific agent 304 and/or checking metadata found to be accurate by the domain-specific agent 304, the verifier(s) 136 can focus its validation check on the errors (e.g., positive results) in the metadata found by the domain-specific agent 304. Thus, the verifier(s) 136 can check the errors found by the domain-specific agent 304 to determine whether to validate the errors. By limiting the scope of the validation checks of the verifier(s) 136, the verifier(s) 136 can provide a more focused validation result with a higher accuracy, and reduce potential errors or hallucinations.

Once the verifier(s) 136 performs a validation check, the verifier(s) 136 can generate an output 320 indicating whether the domain-specific agent's output checked is validated or not. In some cases, if the verifier(s) 136 finds an error in the output from a domain-specific agent, the verifier(s) 136 can correct the error or generate a notification used to trigger the domain-specific agent (and/or a different domain-specific agent) to check and/or correct the error. The verifier(s) 136 can provide the notification to the domain-specific agent and/or to the coordinator 132. In some cases, if the verifier(s) 136 provides the notification to the coordinator 132, the coordinator 132 can use the notification to instruct the domain-specific agent (and/or another domain-specific agent) to check and/or correct the error, and/or the coordinator 132 can check and/or correct the error using higher-level information about the entity associated with the agentic AI system 130, the jobs of the entity, the workflows of the entity, the domains of the entity, etc.

In some cases, the verifier(s) 136 can generate the output 320 and provide the output 320 to another system or to a display for presentation to a human operator. In other cases, the verifier(s) 136 can provide the output 320 to the coordinator 132. The coordinator 132 can then provide the output 320 to another system or to a display for presentation to a human operator. In some cases, the coordinator 132 can optionally perform a check on the output 320 prior to providing the output 320 to another system, presenting the output 320 to a human operator, or using the output 320. In some examples, the coordinator 132 may only check the output 320 if the output 320 indicates that the verifier(s) 136 found an error in an output from a domain-specific agent. For example, the coordinator 132 can check the output 320 for any notifications indicating that an error was found in an output from a domain-specific agent and/or indicating that an output from a domain-specific agent failed a validation test. If the coordinator 132 determines from the output 320 that an error was found or an output was not validated, the coordinator 132 can check the output from the domain-specific agent or instruct the domain-specific agent (and/or any other domain-specific agents) to perform the job again, check the output, and/or correct the error found by the verifier(s) 136.

In some cases, the coordinator 132, the domain-specific agents 134, and/or the verifier(s) 136 can collect data from one or more external sources, such as the data source(s) 126 shown in FIG. 1, and use such data to verify any of their outputs and/or ensure that their outputs do not include any model hallucinations. For example, the domain-specific agents 134 can retrieve domain-specific data from the data source(s) 126 and use the domain-specific data to help the domain-specific agents 134 generate their respective outputs and/or to verify that the respective outputs do not include model hallucinations. To illustrate, assume that the domain-specific agent 304 is configured to check the metadata of media content items received from a content provider(s). In this example, the domain-specific agent 304 can optionally retrieve a copy of metadata associated with the media content items from a metadata source, such as a media content metadata database or the Internet, and use the copy of metadata to an output generated by the domain-specific agent 304 when checking the metadata associated with the media content items (e.g., to ensure that the metadata check performed by the domain-specific agent 304 is accurate) and/or ensure that the output from the metadata check performed by the domain-specific agent 304 does not include a model hallucination.

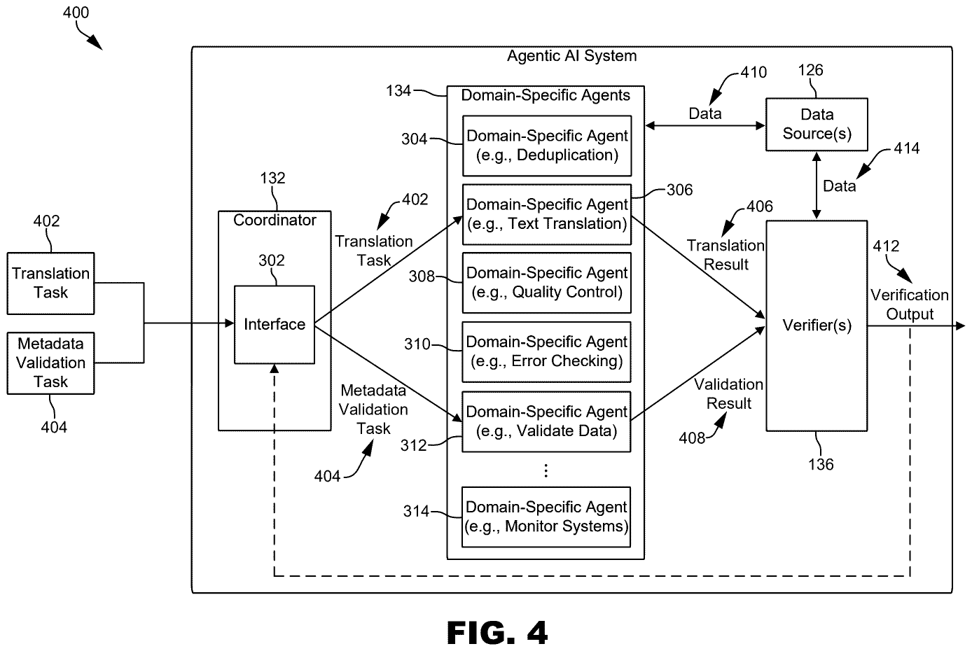

FIG. 4 illustrates an example system process 400 for using the agentic AI system 130 to automate various jobs, according to some examples of the present disclosure. In this example, the jobs include a translation task 402 and a metadata validation task 404. However, in other examples, the jobs can include other task in addition to or instead of the translation task 402 and/or the metadata validation task 404. The agentic AI system 130 can automate the jobs (e.g., the translation task 402 and the metadata validation task 404) using selected domain-specific agents from the domain-specific agents 134, and use the verifier(s) 136 to validate the results from the selected domain-specific agents.

The translation task 402 can include a task to translate text associated with one or more media content items from one language to a different language. For example, the translation task 402 can include a task to translate closed captions in one or more movies and/or TV shows from one language to a different language. The metadata validation task 404 can include a task to validate metadata associated with the one or more media content items. For example, the metadata validation task 404 can include a task to validate titles, release years, cast information, country information, genre information, and/or any other metadata information associated with the one or more movies and/or TV shows.

The coordinator 132 can analyze the translation task 402 and the metadata validation task 404 to determine which domain-specific agent(s) from the domain-specific agents 134 to route the translation task 402 and the metadata validation task 404 to. For example, the coordinator 132 can match the translation task 402 with the domain-specific agent 306, which in this example represents a translation agent, and route the translation task 402 to the domain-specific agent 306. Similarly, the coordinator 132 can match the metadata validation task 404 with the domain-specific agent 312, which in this example represents a data validation agent, and route the metadata validation task 404 to the domain-specific agent 312.

In the example shown in FIG. 4, the domain-specific agent 304 represents an agent trained and/or customized for a data deduplication domain, the domain-specific agent 306 represents an agent trained and/or customized for a text translation domain, the domain-specific agent 308 represents an agent trained and/or customized for a QC domain (e.g., perform QC checks on a content and/or artwork of media content items), the domain-specific agent 310 represents an agent trained and/or customized for an error checking domain (e.g., checking errors in a content pipeline), the domain-specific agent 312 represents an agent trained and/or customized for a data validation domain, and the domain-specific agent 314 represents an agent trained and/or customized for a system health monitoring domain. In some examples, the coordinator 132 can route tasks to specific domain-specific agents based on a match, relevance, similarity/distance, and/or association between respective domains of the tasks and respective domains of the particular domain-specific agents.

For example, the coordinator 132 can determine that the translation task 402 corresponds to a text translation domain, and the metadata validation task 404 corresponds to a data validation domain. The coordinator 132 can determine that the domain-specific agent 306 is trained and/or customized for a text translation domain, and route the translation task 402 to the domain-specific agent 306 based on a match, relevance, similarity/distance, and/or association between the text translation domain of the translation task 402 and the text translation domain of the domain-specific agent 306. Similarly, the coordinator 132 can determine that the domain-specific agent 312 is trained and/or customized for a data validation domain, and route the metadata validation task 404 to the domain-specific agent 312 based on a match, relevance, similarity/distance, and/or association between the data validation domain of the metadata validation task 404 and the data validation domain of the domain-specific agent 312.

In some cases, the coordinator 132 can generate embeddings, such as vectors, encoding the respective domains of the domain-specific agents 134 and embeddings encoding the domains of the translation task 402 and the metadata validation task 404. The coordinator 132 can compare the embedding of the translation task 402 with the embeddings encoding the respective domains of the domain-specific agents 134, and select the domain-specific agent 306 for the translation task 402 based on a match or a distance/similarity score between the embedding encoding the domain of the translation task 402 and the embedding encoding the domain of the domain-specific agent 306 (or based on a highest match, a highest similarity score, or a lowest distance score between the embedding of the domain of the translation task 402 and the embedding of the domain of the domain-specific agent 306 relative to the scores between the embedding of the domain of the translation task 402 and the embeddings of the domains of the other domain-specific agents).

The coordinator 132 can use the interface 302 to route the translation task 402 to the domain-specific agent 306 and the metadata validation task 404 to the domain-specific agent 312. In some cases, the coordinator 132 can forward the translation task 402 to the domain-specific agent 306 and the metadata validation task 404 to the domain-specific agent 312. In some examples, the coordinator 132 can send an instruction or call to the domain-specific agent 306 requesting or triggering performance of the translation task 402 by the domain-specific agent 306. Similarly, the coordinator 132 can send an instruction or call to the domain-specific agent 312 requesting or triggering performance of the metadata validation task 404 by the domain-specific agent 312.

The domain-specific agent 306 can receive the translation task 402 (and/or associated instruction or call) from the coordinator 132 and perform the translation task 402. The domain-specific agent 306 can generate a translation result 406, and send the translation result 406 to the verifier(s) 136. Moreover, the domain-specific agent 312 can receive the metadata validation task 404 (and/or associated instruction or call) from the coordinator 132 and perform the metadata validation task 404. The domain-specific agent 312 can generate a validation result 408, and send the validation result 408 to the verifier(s) 136.

The domain-specific agent 306 and/or the domain-specific agent 312 can optionally collect data 410 from the data source(s) 126 that can assist the domain-specific agent 306 and/or the domain-specific agent 312 in generating or verifying the translation result 406 and/or the validation result 408. For example, the domain-specific agent 306 can use the data 410 (or a portion thereof) collected from the data source(s) 126 to verify the translation result 406 or ensure that the translation result 406 does not include a model hallucination. The domain-specific agent 312 can similarly use the data 410 (or a portion thereof) collected from the data source(s) 126 to verify the validation result 408 or ensure that the validation result 408 does not include a model hallucination.

To illustrate, the domain-specific agent 312 can retrieve a copy of media content metadata from a metadata database and the Internet, and use the copy of the media content metadata to verify that the validation result generated based on the metadata validation task 404 is correct and does not include a model hallucination. In this example, the data 410 from the data source(s) 126 can include the copy of the media content metadata and the metadata database and the Internet can represent the data source(s) 126.

The verifier(s) 136 can receive the translation result 406 and check the translation result 406 for any errors or inaccuracies to determine whether to validate the translation result 406 or generate an error (or notification of an error) identifying any errors or inaccuracies in the translation result 406 (or indicating that the translation result 406 did not pass the validation check). The verifier(s) 136 can also receive the validation result 408 and check the validation result 408 for any errors or inaccuracies to determine whether to validate the validation result 408 or generate an error (or notification of an error) identifying any errors or inaccuracies in the validation result 408 (or indicating that the validation result 408 did not pass the validation check). In some cases, if the validation result 408 identifies any validation errors, the verifier(s) 136 can check the validation errors to confirm whether the validation errors are correct or determine whether the validation error found by the domain-specific agent 314 is incorrect.

The verifier(s) 136 can analyze the translation result 406 and the validation result 408 to perform a validation check on the translation result 406 and the validation result 408. The verifier(s) 136 can then generate a verification output 412 based on the validation check it performs on the translation result 406 and the validation result 408. If the translation result 406 and the validation result 408 pass the validation check performed by the verifier(s) 136 (e.g., if the verifier(s) 136 validates the translation result 406 from the domain-specific agent 306 and the validation result 408 from the domain-specific agent 312), the verification output 412 can include the translation result 406 and the validation result 408. In some cases, if the translation result 406 and the validation result 408 pass the validation check performed by the verifier(s) 136, the verification output 412 can additionally or alternatively include an indication that the translation result 406 and the validation result 408 passed the validation check performed by the verifier(s) 136.

As previously noted, if the validation check of the translation result 406 and/or the validation result 408 performed by the verifier(s) 136 fail/fails (e.g., if the verifier(s) 136 finds an error in the translation result 406 and/or the validation result 408), the verification output 412 can include an indication that the translation result 406 and/or the validation result 408 did not pass the validation check (and/or that the translation result 406 and/or the validation result 408 includes/include one or more errors). In some cases, the verification output 412 can additionally or alternatively indicate why the translation result 406 and/or the validation result 408 did not pass the validation check, identify any errors found in the translation result 406 and/or the validation result 408, correct any errors in the translation result 406 and/or the validation result 408, indicate or suggest how the translation result 406 and/or the validation result 408 can be corrected, and/or include any other information.

In some examples, the verifier(s) 136 can optionally obtain data 414 from the data source(s) 126 and use the data 414 to help the verifier(s) 136 check/validate the translation result 406 and/or the validation result 408. For example, if the translation result 406 includes a translation of closed captions of a movie, the verifier(s) 136 can optionally retrieve a copy of the translated closed captions of the movie from the data source(s) 126 and use the copy of the translated closed captions to check the translation result 406 and/or ensure that the translation result 406 does not include a model hallucination.

In some cases, if the verification output 412 includes an indication that the translation result 406 and/or the validation result 408 failed the validation check performed by the verifier(s) 136, the verifier(s) 136 can send the verification output 412 with such indication to the coordinator 132. The coordinator 132 can check the verification output 412 from the verifier(s) 136, the translation result 406, and/or the validation result 408 to determine whether the translation result 406 and/or the validation result 408 correctly or incorrectly failed the validation check (e.g., whether the translation result 406 and/or the validation result 408 indeed include an error or inaccuracy). In some cases, if the verification output 412 includes an indication that the translation result 406 failed the validation check, the coordinator 132 can send a request to the domain-specific agent 306 (and any other domain-specific agent) to perform the translation task 402 again or check the translation result 406. In some cases, if the verification output 412 includes an indication that the validation result 408 failed the validation check, the coordinator 132 can similarly send a request to the domain-specific agent 306 (and any other domain-specific agent) to perform the metadata validation task 404 again or check the validation result 408.

In some cases, if the translation result 406 fails the validation check, the verifier(s) 136 can additionally or alternatively send the indication that the translation result 406 did not pass the validation check (and/or any information about validation failure of the translation result 406, such as why the translation result 406 did not pass the validation check, any errors identified, how to correct any errors found, etc.) to the domain-specific agent 306 (and/or any other domain-specific agent) so the domain-specific agent 306 (and/or any other domain-specific agent) can check the translation result 406 or perform the translation task 402 again. The indication can trigger the domain-specific agent 306 (and/or any other domain-specific agent) to check the translation result 406 or perform the translation task 402 again. Similarly, if the validation result 408 fails the validation check, the verifier(s) 136 can additionally or alternatively send the indication that the validation result 408 did not pass the validation check (and/or any information about validation failure of the validation result 408, such as why the validation result 408 did not pass the validation check, any errors identified, how to correct any errors found, etc.) to the domain-specific agent 312 (and/or any other domain-specific agent) so the domain-specific agent 312 (and/or any other domain-specific agent) can check the validation result 408 or perform the metadata validation task 404 again. The indication can trigger the domain-specific agent 312 (and/or any other domain-specific agent) to check the validation result 408 or perform the metadata validation task 404 again.

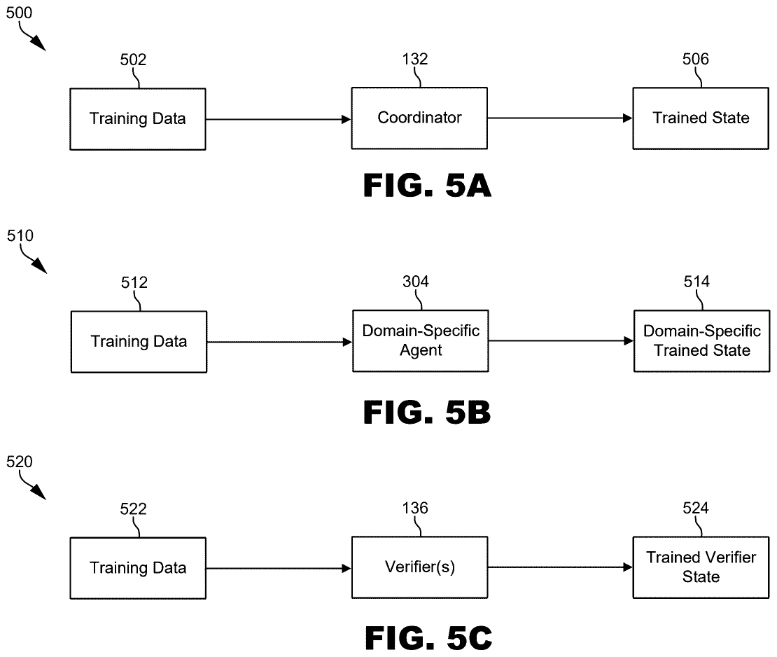

FIG. 5A illustrates an example training process 500 for training the coordinator 132, according to some examples of the present disclosure. As shown, the coordinator 132 can receive training data 502 and use the training data 502 to achieve a trained state 506. The trained state 506 can include a model configuration learned by the coordinator 132 based on the training data 502. For example, the training state 506 can include a set of model parameters (e.g., weights, biases, etc.) learned by the coordinator 132 based on the training data 502. The coordinator 132 can implement the trained state 506 to route jobs as described herein. In some examples, to achieve the trained state 506, the coordinator 132 can process the training data 502 in various iterations used to adjust the parameters of the coordinator 132 until a loss or error of the outputs from the coordinator 132 reach a certain accuracy and/or is below a threshold.

In some examples, to achieve the trained state 506, the coordinator 132 can use the training data 502 to learn which model parameters allow the coordinator 132 to accurately route jobs to selected domain-specific agents from the domain-specific agents 134. In other words, the trained state 506 can represent a configuration of the coordinator 132 when the coordinator 132 has learned to accurately route jobs to specific domain-specific agents. As part of the training, the coordinator 132 can learn to determine which domain-specific agents are the best candidates to handle specific jobs in order to route the specific jobs to such candidate domain-specific agents. For example, the coordinator 132 can learn to match jobs to selected domain-specific agents from the domain-specific agents 134, and route the jobs to the selected domain-specific agents.

In some examples, the coordinator 132 can learn to extract domains from jobs and use the extracted domains to match the jobs to specific domain-specific agents from the domain-specific agents 134. For example, the trained state 506 of the coordinator 132 can allow the coordinator 132 to determine which domains correspond (e.g., which domains are the best or highest/closest match, are most relevant to, represent, have a highest correlation score, have a highest correspondence score, have the highest similarity, reflect the closest relationship, etc.) to specific jobs and identify which of the domain-specific agents 134 should handle the specific jobs based on the respective domains of the domain-specific agents 134 and the domains corresponding to the specific jobs.

To illustrate, in the trained state 506, the coordinator 132 can analyze a job to be performed by the domain-specific agents 134 to associate the job with a domain (e.g., based on a score quantifying, reflecting, and/or representing a matching/overlap amount, a similarity or dissimilarity, a relevance, a correspondence, a relationship, a distance, a confidence, and/or a correlation) and/or identify a domain that corresponds, matches, and/or relates to the job or to associate with the job. The coordinator 132 can compare the job's domain (e.g., the domain associated with the job) with the respective domains of the domain-specific agents 134 to identify which domain-specific agent has expertise in the job's domain (e.g., which domain-specific agent is associated with the job's domain) or a domain that is most relevant to the job's domains. For example, as part of the training to achieve the trained state 506, the coordinator 132 can learn to correlate a job with a domain that has a highest relevance or correspondence (e.g., relationship strength, amount, confidence, direction, etc.) to the job and/or a domain that includes certain information, capabilities, and/or data associated with (e.g., used for, needed to perform, included in, etc.) the job. The coordinator 132 can also learn the respective domains of the domain-specific agents 134 and compare the respective domains of the domain-specific agents 134 with the job's domain to match or correlate the job's domain with a specific domain from the respective domains associated with the domain-specific agents 134. The coordinator 132 can select a domain-specific agent for the job based on the specific domain correlated with the job's domain, and route the job to that domain-specific agent. Here, the domain-specific agent can be a particular domain-specific agent from the domain-specific agents 134 that is associated with the specific domain correlated with the job's domain.

In some examples, to correlate the job's domain with a specific domain from the respective domains of the domain-specific agents 134, the coordinator 132 can learn to identify which of the respective domains of the domain-specific agents 134 best matches, has a highest relevance to, has a highest overlap with, and/or has a highest similarity to the job's domain, and select a domain-specific agent (or multiple) from the domain-specific agents 134 for the job based on the respective domain determined to best match, have a highest relevance to, have a highest overlap with, and/or have a highest similarity to the job's domain. The selected domain-specific agent can include the domain-specific agent (or multiple) associated with the respective domain determined to best match, have a highest relevance to, have a highest overlap with, and/or have a highest similarity to the job's domain.

For example, the coordinator 132 can learn to analyze a job to identify a domain associated with the job. The domain associated with the job can be identified based on a topic of the job, a field or subject area of the job, a type of knowledge or expertise used or is needed to perform the job, a type of information associated with the job or used/needed to perform the job, a job category, a principle or capability used or is needed to perform the job, a type of content or file associated with the job (e.g., audio, video, image data, text, etc.), a type of output associated with the job, a system associated with the job, a service associated with the job, an attribute of the job, an operation associated with the job, and/or any characteristic of the job. The coordinator 132 can also learn the respective domains of the domain-specific agents 134, which the coordinator 132 can use to select domain-specific agents for specific jobs. Thus, the coordinator 132 can learn to correlate the job's domain with a specific domain from the respective domains of the domain-specific agents 134. Once the coordinator 132 correlates the job's domain with the specific domain from the respective domains of the domain-specific agents 134, the coordinator 132 can select the domain-specific agents associated with the specific domain, and route the job to the selected domain-specific agent. The selected domain-specific agent can include a domain-specific agent trained or customized for the specific domain correlated with the job's domain.

To illustrate, if a job includes deduplicating data, the coordinator 132 can determine that the job includes or relates to a data deduplication domain. The coordinator 132 can determine whether any of the respective domains of the domain-specific agents 134 match the data deduplication domain associated with the job (e.g., determine whether the respective domains include a data deduplication domain). If a respective domain matches the data deduplication domain associated with the job (e.g., if the respective domains of the domain-specific agents 134 includes a data deduplication domain), the coordinator 132 can select the domain-specific agent associated with the data deduplication domain for the job, and route the job to that domain-specific agent. If none of the respective domains of the domain-specific agents 134 match the data deduplication domain associated with the job, the coordinator 132 can determine which of the respective domains best matches, has the highest similarity to, has a highest relevance to, and/or has a highest overlap with the data deduplication domain associated with the job, and select the domain-specific agent associated with that respective domain for the job.

The training data 502 used to train the coordinator 132 can include data identifying the respective domains of the domain-specific agents 134. For example, the training data 502 can map domains to domain-specific agents to allow the coordinator 132 to learn which domains correspond to which domain-specific agents. In some cases, the training data 502 can additionally or alternatively include data from and/or about each of the respective domains of the domain-specific agents 134. Such data can allow the coordinator 132 to learn about the respective domains of the domain-specific agents 134, obtain a level of expertise in the respective domains, and/or correlate the domain-specific agents 134 to the respective domains so the coordinator 132 knows which domain corresponds to which domain-specific agent.

In some cases, the training data 502 can include data about the systems of an entity implementing the agentic AI system 130, the processes of the entity, the workflows of the entity, the operations of the entity, any data of the entity, any rules and/or requirements of the entity, any operational data of the entity, any pipelines of the entity (e.g., any processing and/or data pipelines), any end-to-end workflows/pipelines of the entity, a context of the entity, any domains associated with the entity, and/or any other data associated with the entity. Such data can allow the coordinator 132 to obtain knowledge about the entity, its systems, its processes, its data, its workflows, its rules and/or requirements, its operations, its pipelines, its domains, etc., which can help the coordinator 132 select (or more accurately select) domain-specific agents for jobs. Thus, the trained state 506 of the coordinator 132 can represent a configuration of the coordinator 132 that includes or reflects domain-wide knowledge, system-wide knowledge, entity-wide knowledge, etc.

In some examples, the training data 502 can include example jobs used to train the coordinator 132 to correlate jobs with specific domains, and select (and/or match) domain-specific agents for the jobs based on the specific domains correlated with the jobs and the respective domains of the domain-specific agents 134. In some cases, the training data 502 can include ground truth data that the coordinator 132 can use to calculate losses/errors in the output(s) generated at each training iteration. The coordinator 132 can use such losses/errors to adjust its configuration (e.g., parameters) until it achieves the trained state 506. For example, the training data 502 can include example jobs that are pre-correlated with specific domains. The coordinator 132 can use the pre-correlation of the example jobs with specific domains to calculate any losses/errors in the domains it identifies for the example jobs. The training data 502 can optionally include an indication of specific domain-specific agents pre-selected for the example jobs, which the coordinator 132 can use to calculate any losses/errors in the domain-specific agents it selects for the example jobs, and update its configuration (e.g., parameters) based on such losses/errors.

FIG. 5B illustrates an example training process 510 for training a domain-specific agent from the domain-specific agents 134, according to some examples of the present disclosure. In this example, the domain-specific agent 304 can represent an AI agent being trained for a specific domain(s). The specific domain(s) can be based on or correspond to an operating domain (e.g., NLP, NLU, automatic speech recognition (ASR), data deduplication, quality control, language translation, system monitoring, content recommendations, legal document understanding, content pipeline validation and/or correction, metadata validation and/or error correction, image processing, video processing, computer/machine vision, segmentation, etc.), a type of content or data (e.g., audio, text, video, image data, closed captions, metadata, code, data objects, etc.), a subject area or expertise, a processing capability, a topic or category, and/or any other knowledge domain.

The domain-specific agent 304 can process the training data 512 in training iterations used to adjust a configuration (e.g., parameters) of the domain-specific agent 304 until the domain-specific agent 304 achieves a domain-specific trained state 514. For example, the domain-specific agent 304 can process training data to generate an output at each training iteration. The domain-specific agent 304 can calculate a loss/error of the output at each training iteration and adjust a configuration (e.g., parameters) of the domain-specific agent 304 based on the loss/error at each training iteration. The domain-specific agent 304 can continue with training iterations until it generates an output with a certain accuracy or a loss/error below a threshold. The domain-specific trained state 514 can represent the configuration (e.g., parameters) of the domain-specific agent 304 when it completes training. The domain-specific trained state 514 can thus reflect a state of the domain-specific agent 304 when the domain-specific agent 304 has obtained expertise in the specific domain and/or learned to perform jobs associated with the specific domain.

The training data 512 used to train the domain-specific agent 304 can include any data associated with the specific domain of the domain-specific agent 304. For example, the training data 512 can include, without limitation, a knowledgebase of the specific domain (e.g., information about and/or from the specific domain), example inputs associated with the specific domain, ground truth data from the specific domain, principles associated with the specific domain, articles and/or books associated with the specific domain, example data from the specific domain, and/or any other information associated with the specific domain.

For example, if the specific domain includes a natural language processing (NLP) domain, the training data 512 can include NLP training data such as, for example and without limitation, vocabulary/dictionary data, semantic data, syntax data, example text data (e.g., example words, sentences, paragraphs, text metadata, text labels, closed captions, subtitles, etc.), ground truth NLP data, sentiment data, a lexicon, tokens, speech units (e.g., phonemes, etc.), context data, text classifications, audio data, a grammar, video data, and/or any other NLP training data. As another example, if the specific domain includes an image processing domain, the training data 512 can include image data used to train the domain-specific agent 304 to process image data and perform image processing operations. In some cases, the training data 512 can optionally include ground truth data, such as correct image processing outputs associated with the input image data.

The training process 510 can be used to train each of the domain-specific agents 134 for a respective domain. Non-limiting examples of domains that the domain-specific agents 134 can be trained/customized for in the context of the multimedia environment 102 shown in FIG. 1 can include language translation, checking an accuracy of a list of content items (and/or associated titles) received from one or more content providers based on a legal document(s)/agreement(s) defining which content items the one or more content providers are supposed to provide, checking whether the artwork associated with content items is correct (and/or correcting errors in the artwork), checking the metadata associated with the content items for any errors, checking for any errors in a content pipeline used to process and/or publish the content items received from the one or more content providers (and/or fixing any errors in the content pipeline or suggesting corrections), deduplicating duplicate content items, monitoring a health of any systems in the multimedia environment 102 (and/or correcting or suggesting corrections for any problems detected), adjusting a configuration of a content recommendations model to improve the recommendations from the model, classifying the content items, automating QC operations, generating closed captions and/or subtitles, etc.

FIG. 5C illustrates an example training process 520 for training the verifier(s) 136 to verify/validate outputs from the domain-specific agents 134, according to some examples of the present disclosure. The verifier(s) 136 can be trained using the training data 522 to obtain a trained verifier state 524. The trained verifier state 524 can include a configuration (e.g., parameters) of the verifier(s) 136 determined, adjusted, or achieved through the training of the verifier(s) 136.

To train the verifier(s) 136, the verifier(s) 136 can process the training data 522 (or portions thereof) in various training iterations used to identify adjustments to the verifier(s) 136. At each training iteration, the verifier(s) 136 can generate an output(s) and calculate a loss/error of the output(s). The verifier(s) 136 can adjust a configuration (e.g., parameters) of the verifier(s) 136 based on the loss/error calculated to improve the accuracy of its outputs (e.g., to learn). The verifier(s) 136 can perform training iterations until the output of the verifier(s) 136 achieves a certain accuracy and/or has a loss/error that is below a threshold. The trained verifier state 524 represents the configuration of the verifier(s) 136 when the verifier(s) 136 achieves the desired accuracy and/or has a loss/error that is below the threshold.

In some cases, the verifier(s) 136 can be trained for each of the respective domains of the domain-specific agents 134. In some examples, the verifier(s) 136 can be trained to check and/or validate outputs from each of the domain-specific agents 134. In some cases, the verifier(s) 136 can be trained to determine whether outputs from the domain-specific agents 134 include any errors/inaccuracies and optionally correct the errors/inaccuracies or suggest how to correct the errors/inaccuracies.

The training data 522 used to train the verifier(s) 136 can include example outputs from the domain-specific agents 134. For example, assume that the domain-specific agents 134 include domain-specific agents trained/customized for language translation, metadata QC checks, QC checks of artwork associated with media content items, validating lists of content items against legal documents/agreements specifying the correct lists of content items, monitoring a health of a system, validating a content pipeline, check content recommendation results and adjust associated content recommendation models, and data deduplication. In this example, the training data 522 can include example translation outputs, metadata QC outputs, media content item artwork QC outputs, system health monitoring outputs, outputs from validations of lists of content items against legal documents/agreements, content pipeline validation outputs, content recommendation outputs and/or recommended content recommendation model adjustments, and data deduplication outputs. The verifier(s) 136 can process example domain-specific agent outputs in each training iteration to learn and make adjustments as previously explained.

In some cases, the training data 522 can include data from the respective domains of the domain-specific agents 134. For example, the training data 522 can include knowledgebases, articles, books, example inputs, example outputs, example data, and/or any other information about and/or from the respective domains of the domain-specific agents 134. This way, the verifier(s) 136 in the trained verifier state 524 can achieve a degree of knowledge or expertise in the respective domains of the domain-specific agents 134, which can help the verifier(s) 136 check outputs from the domain-specific agents 134.

In some cases, the training data 522 can also include information about an associated entity, operations of the entity, data of the entity, workflows of the entity, pipelines of the entity, outputs of the entity, systems of the entity, processes of the entity, a business of the entity, end-to-end procedures of the entity, rules and/or requirements of the entity, preferences of the entity, and/or any other data associated with the entity. Such data can allow the verifier(s) 136 to obtain a degree of knowledge about the entity, its processes, its operations, its business, its data, its workflows, its rules and/or requirements, its preferences, etc., which can help verifier(s) 136 check outputs from the domain-specific agents 134 and/or can provide contextual information that the verifier(s) 136 can use to improve the accuracy of its validation checks.

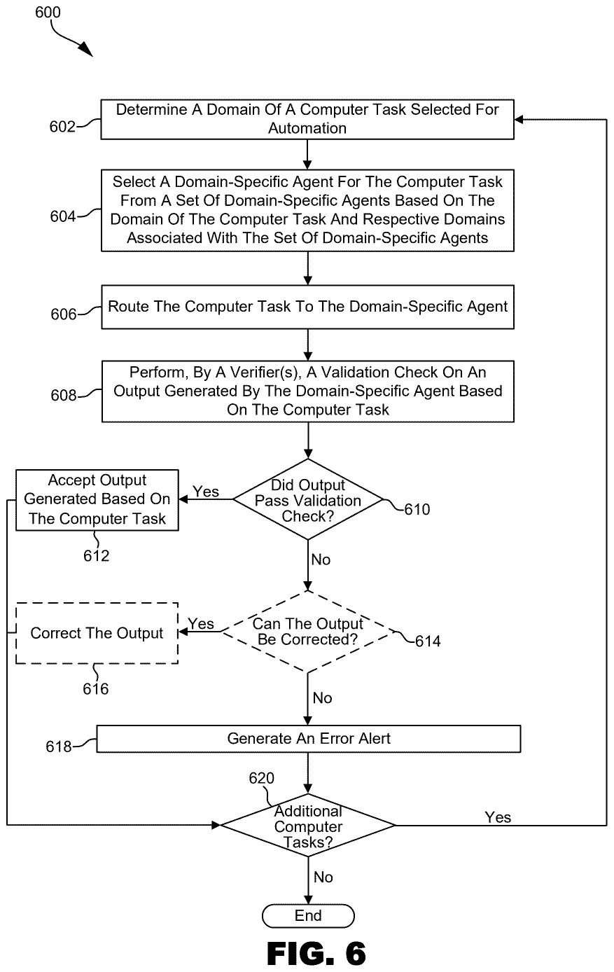

FIG. 6 is a flowchart illustrating an example method 600 for using the agentic AI system 130 to automate jobs, according to some examples of the present disclosure. The method 600 can be performed by processing logic that can include hardware (e.g., circuitry, dedicated logic, programmable logic, microcode, etc.), software (e.g., instructions executing on a processing device), or a combination thereof. It is to be appreciated that not all steps may be needed to perform the method 600. Further, some of the steps may be performed simultaneously, or in a different order than shown in FIG. 6, as will be understood by a person of ordinary skill in the art. Method 600 shall be described with reference to FIGS. 1 and 3. However, method 600 is not limited to those examples.

At step 602, the coordinator 132 can determine a domain of a computer task selected for automation by the agentic AI system 130. As previously noted, the coordinator 132 can include one or more AI or ML models, such as one or more LLMs, transformers, CNNs, autoencoders, encoder-decoder networks, RNNs, and/or any other AI/ML models. Moreover, the computer task can include one or more tasks, operations, functions, workflows, and/or any other computer-implemented actions.

For example, in some cases, the computer task can include validating a list of media content items (e.g., movies, TV shows, video games, video clips, etc.) provided by a content provider against a legal document identifying what media content items the content provider has agreed to provide to an entity associated with the agentic AI system 130, such as a media content platform. In another example, the computer task can additionally or alternatively include a QC task for checking metadata received by a content provider with associated content items for any errors, and optionally fixing (or suggesting how to fix) any errors found in the metadata. In another example, the computer task can additionally or alternatively include checking a content pipeline for errors and optionally fixing (or suggesting how to fix) any errors found in the content pipeline, monitoring a system health, deduplicating duplicate copies of data received from one or more content providers, identifying (and optionally applying) adjustments (e.g., parameter and/or configuration adjustments) to an AI/ML content recommendation model(s) used to recommend content to users, and/or any other computer task.

At step 604, the coordinator 132 can select a domain-specific agent for the computer task from the domain-specific agents 134 based on the domain of the computer task and respective domains of the domain-specific agents 134. For example, the coordinator 132 can compare the domain of the computer task with the respective domains of the domain-specific agents 134 to identify a domain from the respective domains that best matches, correlates to, relates to, and/or encompasses the domain of the computer task. The coordinator 132 can identify which domain-specific agent from the domain-specific agents 134 corresponds to the domain identified from the respective domains (e.g., the domain that best matches, correlates to, relates to, and/or encompasses the domain of the computer task), and select that domain-specific agent for the computer task.

In some cases, to select a domain-specific agent for the computer task, the coordinator 132 can compare the domain of the computer task with each of the respective domains of the domain-specific agents 134 to determine a comparison score for each of the respective domains. The comparison score of a particular domain can indicate whether the particular domain matches the domain of the computer task and/or a similarity, distance, overlap, and/or relevance of the particular domain with respect to the domain of the computer task. The coordinator 132 can select the domain-specific agent based on the comparison scores of the respective domains of the domain-specific agents 134. For example, the coordinator 132 can select the domain-specific agent associated with the domain that has the comparison score that indicates a match with the domain of the computer task or a highest similarity, highest overlap, highest relevance, and/or lowest distance to the domain of the computer task, such as the highest comparison score.

In some examples, the coordinator 132 can compare specific operations, information, and/or capabilities associated with the domain of the computer task with operations, information, and/or capabilities of the respective domains of the domain-specific agents 134 to identify which domain-specific agent is most suitable for the computer task. For example, the coordinator 132 can identify which domain from the respective domains is associated with operations, information, and/or capabilities that best match, correspond to, and/or relate to the specific operations, information, and/or capabilities associated with the domain of the computer task, and select the domain-specific agent associated with the identified domain.

In some cases, the coordinator 132 can select a single domain-specific agent for the computer task. In other cases, the coordinator 132 can select multiple domain-specific agents for the computer task. For example, the coordinator 132 can select a domain-specific agent for a subtask of the computer task, and a different domain-specific agent for another subtask of the computer task.

At step 606, the coordinator 132 can route the computer task to the domain-specific agent selected for the computer task. The domain-specific agent can perform the computer task and generate an output. The output can include one or more outputs, such as one or more data outputs, responses, decisions, suggestions, etc. The domain-specific agent can provide the output to the verifier(s) 136, which can perform a validation check on the output.

At step 608, the verifier(s) 136 can perform a validation check on the output generated by the domain-specific agent based on the computer task (e.g., an output for/from the computer task). For example, the verifier(s) 136 can check whether the output includes any errors/inaccuracies or whether the output is correct. In some cases, the verifier(s) 136 can check specific portions or information in the output, such as errors identified in the output, recommendations included in the output, decisions in the output, values in the output, etc.

At step 610, the verifier(s) 136 can determine whether the output passed the validation check. The verifier(s) 136 can determine that the output passed the validation check if the verifier(s) 136 did not find any errors, inaccuracies, and/or hallucinations in the output or if it only found errors, inaccuracies, and/or hallucinations that do not affect an outcome associated with the output. For example, if the output includes an error identified in a QC check, the verifier(s) 136 can try to validate/verify or confirm the error. If the verifier(s) 136 validates/verifies or confirms the error, the verifier(s) 136 can determine that the output passes the validation check. If the verifier(s) 136 determines that the error was incorrectly found (e.g., a false positive, a mistake, etc.), the verifier(s) 136 can determine that the output does not pass the validation check.

At step 612, if the output passes the validation check, the verifier(s) 136 can accept the output. Accepting the output can include passing/sending the output to a user or system intended to receive the output, generating a message indicating that the output was validated, applying/implementing the output, and/or performing an action based on the output. The method 600 can then proceed to step 620, where the coordinator 132 can determine if there are any additional computer tasks to automate/perform.

At step 614, if the output does not pass the validation check, the verifier(s) 136 can optionally determine whether the output can be corrected. For example, the verifier(s) 136 can determine whether the output has an error that the verifier(s) 136 can correct. At step 616, if the output can be corrected, the verifier(s) 136 can optionally correct the output. The verifier(s) 136 can generate the corrected output and optionally send the corrected output to a target system or user or apply/implement the corrected output. The method 600 can then proceed to step 620, where the coordinator 132 can determine if there are any additional computer tasks to automate/perform.

At step 618, if the output cannot be corrected, the verifier(s) 136 can generate an error alert. The error alert can indicate that the output includes an error(s), did not pass the validation check, is inaccurate, and/or should not be accepted. The error alert can optionally trigger the domain-specific agent (and/or any other domain-specific agent) to perform the computer task again, or trigger the coordinator 132 to select a domain-specific agent (e.g., the same and/or a different domain-specific agent) to perform the computer task again. In some cases, the error alert can include an instruction or request to the domain-specific agent to check the output or perform the computer task again. In some cases, the error alert can include an instruction or request to the coordinator 132 to check the output or select a domain-specific agent to perform the computer task again.

The method 600 can then proceed to step 620, where the coordinator 132 can determine whether there are any additional computer tasks to automate/perform.

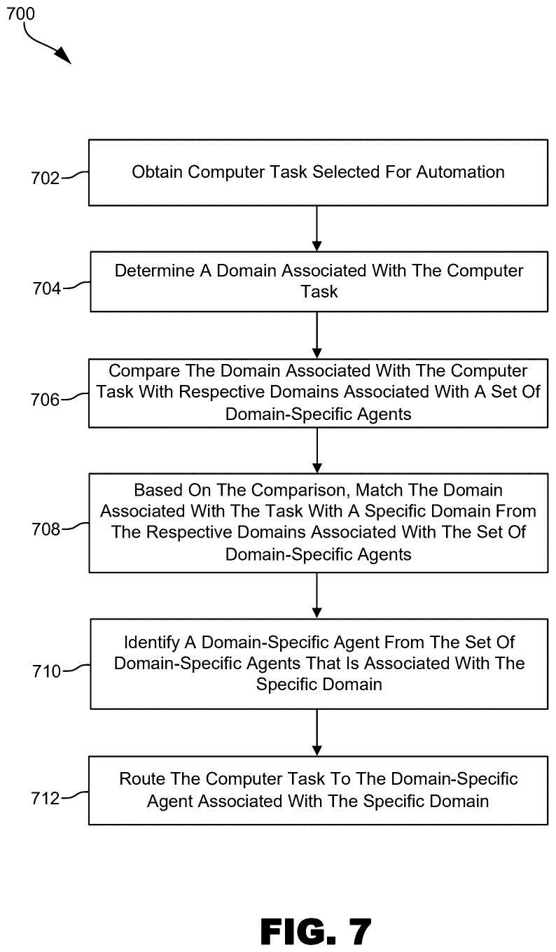

FIG. 7 is a flowchart illustrating an example method 700 for routing jobs to domain-specific agents for automation, according to some examples of the present disclosure. The method 700 can be performed by processing logic that can include hardware (e.g., circuitry, dedicated logic, programmable logic, microcode, etc.), software (e.g., instructions executing on a processing device), or a combination thereof. It is to be appreciated that not all steps may be needed to perform the method 700. Further, some of the steps may be performed simultaneously, or in a different order than shown in FIG. 7, as will be understood by a person of ordinary skill in the art. Method 700 shall be described with reference to FIGS. 1 and 3. However, method 700 is not limited to those examples.

At step 702, the coordinator 132 can obtain a computer task selected for automation. The computer task can include one or more tasks, operations, functions, workflows, and/or any other computer-implemented actions. For example, the computer task can include validating media content items received by a content provider against a legal document specifying a list of media content items that the content provider has agreed to deliver, validating metadata received with the media content items, validating artwork (e.g., covers, thumbnails, etc.) of the media content items received by the content provider, checking a content pipeline for any errors, fixing any errors found in the content pipeline, adjusting one or more parameters of an AI model(s) configured to recommend content to users, perform data deduplication to remove any duplicates received from the content provider, translate closed captions received with the media content items, generate closed captions for the media content items, and/or any other computer tasks.

At step 704, the coordinator 132 can determine a domain associated with the computer task. For example, the coordinator 132 can analyze the computer task to determine a domain that best matches, represents, encompasses, relates to, and/or corresponds to the computer task. In some cases, the coordinator 132 can determine a domain for the computer task based on a type of operation(s) associated with the computer task, a system or type of system associated with the computer task, a capability used or needed to perform the computer task, a dependency of the computer task, information associated with the computer task, a topic or area associated with the computer task, a field of the computer task, a type of task of the computer task, a type of output associated with the computer task, a type of data associated with the computer task, a subject area or technical field of the computer task, and/or any other attributes of the computer task.

In some examples, the coordinator 132 can be trained to analyze the computer task to identify a domain associated with the computer task based on a determination of a type of task of the computer task, capabilities that can be used to perform the computer task, a type of data associated with the computer task, and/or an expertise needed to perform the computer task.

At step 706, the coordinator 132 can compare the domain associated with the computer task with respective domains of the domain-specific agents 134. For example, the coordinator 132 can compare the domain with the respective domains of the domain-specific agents 134 to determine whether any of the respective domains matches the domain or identify which of the respective domains to select for, associate with, or match with the domain of the computer task. In some cases, the coordinator 132 can generate and/or calculate a score for each domain from the respective domains that quantifies, reflects, represents, and/or indicates a respective similarity, distance, overlap, relevance, match (or matching amount, percentage, value, etc.), relationship, and/or correspondence between that domain from the respective domains and the domain associated with the computer task.

The score can be used to associate a domain from the respective domains with the domain of the computer task. For example, the score can be used to identify the domain from the respective domains that has a highest similarity or correspondence to the domain associated with the computer task, has a lowest distance with respect to the domain associated with the computer task, best or most encompasses the domain associated with the computer task, best matches or relates to the domain associated with the computer task, or has a highest overlap with the domain associated with the computer task. The domain identified based on the comparison score can be used to select a domain-specific agent for the computer task. The selected domain-specific agent can include the domain-specific agent associated with the identified domain (e.g., trained or customized for that domain).

In some examples, the coordinator 132 can compare the domain of the computer task with each of the respective domains of the domain-specific agents 134 to determine respective comparison or correspondence scores between the domain of the computer task and the respective domains of the domain-specific agents 134. The respective comparison or correspondence scores can represent, quantify, reflect, and/or measure respective matches (e.g., respective matching amounts and/or matching confidences) between the domain of the computer task and the respective domains of the domain-specific agents 134, respective similarities between the domain of the computer task and the respective domains of the domain-specific agents 134, respective relevances (e.g., relevance amounts and/or confidences) between the domain of the computer task and the respective domains, respective distances between the domain of the computer task and the respective domains of the domain-specific agents 134, respective correspondences between the domain of the computer task and the respective domains of the domain-specific agents 134 (e.g., correspondence values indicating or measuring the strength, confidence, and/or amount of the relationship between the domain of the computer task and the respective domains), etc.

At step 708, the coordinator 132 can match the domain of the computer task with a specific domain from the respective domains associated with the domain-specific agents 134 based on the comparison (e.g., based on a comparison result, a score calculated based on the comparison, etc.). For example, the coordinator 132 can identify a specific domain from the respective domains based on an associated score of the specific domain relative to the scores of the other domains from the respective domains associated with the domain-specific agents 134. The score of the specific domain and the score of the other domains can be calculated or determined based on the comparison of the domain associated with the computer task with the respective domains of the domain-specific agents 134, as previously explained.

In some cases, the coordinator 132 can identify the domain from the respective domains that best matches the domain associated with the computer task, that has a highest similarity to the domain associated with the computer task, that has a lowest distance with respect to the domain associated with the computer task, that has a highest overlap with the domain associated with the computer task, that has a best (e.g., highest) comparison or correspondence score, that has a highest relevance to the domain associated with the computer task, that has a strongest relationship with the domain associated with the computer task, that has a highest correlation or correlation confidence with respect to the domain associated with the computer task, that most encompasses the domain associated with the computer task, that is associated with a lowest error or loss value generated by a model of the coordinator 132 when determining whether such domain should be matched with the domain associated with the computer task, etc.

At step 710, the coordinator 132 can identify a domain-specific agent from the domain-specific agents 134 for the computer task based on the specific domain matched with the domain associated with the computer task. For example, the coordinator 132 can correlate each of the domain-specific agents 134 with a corresponding domain from the respective domains and use the correlation of domains with domain-specific agents to identify which of the domain-specific agents 134 is correlated with the specific domain matched with the domain associated with the computer task.

At step 712, the coordinator 132 can route the computer task to the domain-specific agent identified for the computer task based on the specific domain matched with the domain associated with the computer task. For example, the coordinator 132 can send or relay/forward the computer task to the domain-specific agent identified for the computer task. In some cases, when routing the computer task to the domain-specific agent, the coordinator 132 can trigger the domain-specific agent to perform the computer task. In some examples, when routing the computer task to the domain-specific agent, the coordinator 132 can provide to the domain-specific agent an instruction, command, and/or request to perform the computer task.

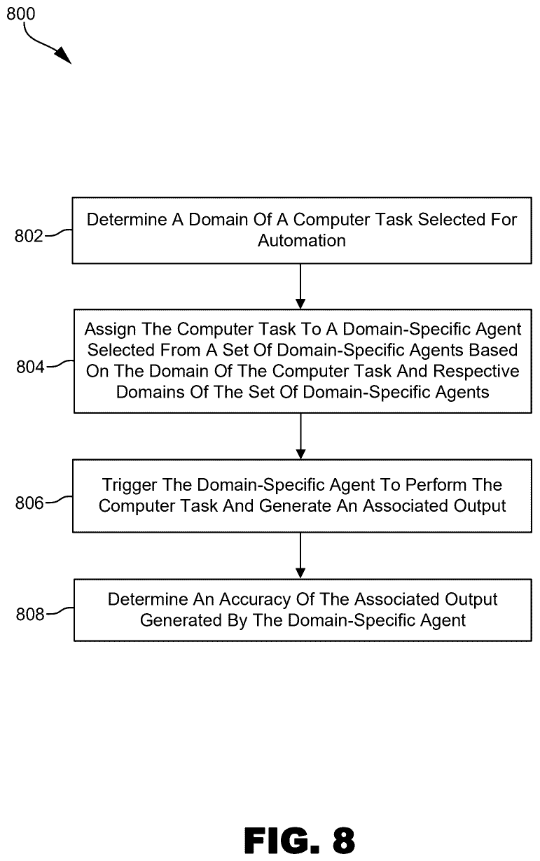

FIG. 8 is a flowchart illustrating an example method 800 for using the agentic AI system 130 to automate jobs, according to some examples of the present disclosure. The method 800 can be performed by processing logic that can include hardware (e.g., circuitry, dedicated logic, programmable logic, microcode, etc.), software (e.g., instructions executing on a processing device), or a combination thereof. It is to be appreciated that not all steps may be needed to perform the method 800. Further, some of the steps may be performed simultaneously, or in a different order than shown in FIG. 8, as will be understood by a person of ordinary skill in the art. Method 800 shall be described with reference to FIGS. 1 and 3. However, method 800 is not limited to those examples.

At step 802, the coordinator 132 can determine a domain of a computer task selected for automation. The coordinator 132 can determine the domain of the computer task as previously explained. For example, the coordinator 132 can determine the domain of the computer task as described with respect to step 602 in FIG. 6 or step 704 in FIG. 7.

In some examples, the coordinator 132 can include an AI model(s) that is trained or customized to identify specific domains associated with computer tasks and assign the computer tasks to domain-specific agents selected for the computer tasks based on respective domains of the domain-specific agents 134 and the specific domains associated with the computer tasks. In some cases, the coordinator 132 can be trained to learn information associated with the respective domains of the domain-specific agents 134, capabilities associated with the respective domains of the domain-specific agents 134, an end-to-end process of an entity associated with the computer task, information about operations of the entity, information about systems of the entity, and/or information about the entity. The coordinator 132 can use such information to help the coordinator 132 select and assign computer tasks to domain-specific agents.

In some aspects, the coordinator 132 can determine information about the computer task and determine the domain of the computer task based on the information. In some examples, the information about the computer task can include a type of operation associated with the computer task, a topic associated with the computer task, a field or category associated with the computer task, a capability needed to perform the computer task, a type of data associated with the computer task, a type of output associated with the computer task, an action associated with the computer task, an attribute of the computer task, a type of computer task, and/or a subject area associated with the computer task and/or information associated with the computer task.

At step 804, the coordinator 132 can assign the computer task to a domain-specific agent selected from the domain-specific agents 134 based on the domain of the computer task and respective domains of the domain-specific agents 134. The coordinator 132 can select the domain-specific agent for the computer task as previously explained. For example, the coordinator 132 can compare the domain of the computer task with the respective domains of the domain-specific agents 134 to determine which domain from the respective domains best matches the domain of the computer task, has a highest similarity to the domain of the computer task, has a highest relevance (and/or relevance confidence) to the domain of the computer task, has a highest correspondence to (e.g., has a strongest and/or greater relationship to) the domain of the computer task, etc. The coordinator 132 can then select the domain-specific agent for the computer task as described with respect to step 604 of FIG. 6 or steps 708 and 710 of FIG. 7, and route the computer task to the selected domain-specific agent. For example, the coordinator 132 can determine the respective domains of the domain-specific agents 134, select the domain-specific agent for the computer task based on a comparison of the domain of the computer task and each of the respective domains, and route the computer task to the domain-specific agent.

In some examples, the coordinator 132 can compare the domain of the computer task with each of the respective domains of the domain-specific agents 134 to determine respective scores between the domain of the computer task and the respective domains, and associate the domain of the computer task with a domain selected from the respective domains based on the respective scores between the domain of the computer task and the respective domains. In some cases, the respective scores can represent, quantify, reflect, measure, and/or indicate respective matches (and/or matching amounts, confidences, percentages, and/or values) between the domain and the respective domains, respective similarities between the domain and the respective domains, respective relevances between the domain and the respective domains, respective distances calculated for the domain and the respective domains, respective relationships between the domain and the respective domains, respective overlaps between the domain and the respective domains, respective comparison or selection error or loss values calculated for the respective domains, respective confidences or confidence scores calculated for the respective domains, and/or any other attribute of the respective domains with respect to the domain of the computer task.

In some aspects, the respective scores can include correspondence scores. The correspondence scores can measure, represent, indicate, reflect, and/or quantify the respective strengths of the relationships between the domain associated with the computer task and the respective domains, the respective relationship amounts between the domain and the respective domains, the respective relationship confidences between the domain and the respective domains, the respective direction of the relationship between the domain and the respective domains, the respective relationship attributes between the domain and the respective domains, and/or respective correlation values indicating a correlation amount between the domain and the respective domains.

The domain of the computer task and/or the respective domains of the domain-specific agents 134 can include a knowledge domain, a processing domain, a data or content domain, a technical domain, an operating domain, a topical domain, an expertise domain, a subject, a field, a body of knowledge, a functionality, a technology, and/or any other category of information, operations, capabilities, systems, outputs, data, fields, topics, subjects, technologies, functionalities, attributes, etc. In some examples, the respective domains can include, without limitation, language translation, data deduplication, content recommendation, model optimization, text processing, image processing, computer vision, validating content from a provider based on a document identifying what content the provider has agreed to deliver to an entity, quality control of metadata associated with the content from the provider, validating covers or artwork of the content delivered by the provider, detecting or correcting errors in any content pipelines associated with the entity, monitoring a health of one or more systems associated the entity, determining an updated configuration of a content recommendation platform, and/or any other domain.

At step 806, the coordinator 132 can trigger the domain-specific agent to perform the computer task and generate an associated output. In some cases, the coordinator 132 can trigger the domain-specific agent to perform the computer task as part of assigning the computer task to the domain-specific agent. In some cases, the coordinator 132 can route the computer task to the domain-specific agent. In some examples, routing the computer task to the domain-specific agent can trigger the domain-specific agent to perform the computer task. In other examples, the coordinator 132 can provide the domain-specific agent an instruction or request to perform the computer task, which can trigger the domain-specific agent to perform the computer task.

The domain-specific agent can then perform the computer task and generate the associated output. The domain-specific agent can provide the associated output to the verifier(s) 136 for verification/validation. The associated output can include, for example and without limitation, a response, a decision, output data, a request, a suggestion, an instruction, a value, a parameter, a notification, a message, processed data, a content item, a determination, and/or any other output. The domain-specific agent can optionally collect information from the data source(s) 126, which can help the domain-specific agent generate the associated output or the domain-specific agent can use to validate the associated output before providing the associated output to the verifier(s) 136. For example, if the computer task includes validating metadata associated with movies or TV shows, the domain-specific agent can collect movie or TV show metadata from a metadata database (e.g., data source(s) 126) and use the collected metadata to determine whether the validation result (e.g., the associated output) generated by the domain-specific agent is accurate (e.g., that the domain-specific agent correctly validated the metadata).

At step 808, the verifier(s) 136 can determine an accuracy of the associated output generated by the domain-specific agent. In some examples, determining the accuracy of the associated output can include determining whether the associated output includes any errors or inaccuracies, validating the associated output, determining a confidence score for the associated output, or determining a value representing an accuracy level or percentage of the associated output. In some cases, in addition to determining the accuracy of the associated output, the verifier(s) 136 can correct any errors/inaccuracies in the associated output (if any) or suggest how to correct such errors/inaccuracies (if any).

For example, in some cases, determining the accuracy of the associated output generated by the domain-specific agent can include validating the associated output, detecting one or more errors in the associated output, and/or determining a confidence score for the associated output. In some examples, the confidence score can represent a likelihood that the associated output is accurate or complies with one or more requirements.

In some cases, when determining the accuracy of the associated output generated by the domain-specific agent, the verifier(s) 136 can detect one or more errors in the associated output. In such cases, the verifier(s) 136 or the domain-specific agent can then determine how to correct the one or more errors in the associated output, and optionally correct the one or more errors in the associated output or request another model or system to correct the one or more errors.

In some cases, the verifier(s) 136 (and/or the domain-specific agent) can obtain data associated with the computer task from the data source(s) 126, and verify (or determine whether to verify) the associated output based on the data obtained from the data source(s) 126. For example, if the computer task includes validating artwork received from a content provider with a list of media content items, the data can include artwork of the media content items stored in a database containing such artwork. The verifier(s) 136 (and/or the domain-specific agent) can use the artwork from the database to verify whether the domain-specific agent correctly or incorrectly validated (or failed to validate) the artwork received by the content provider when performing the computer task.

### Example Neural Network Architectures and Models

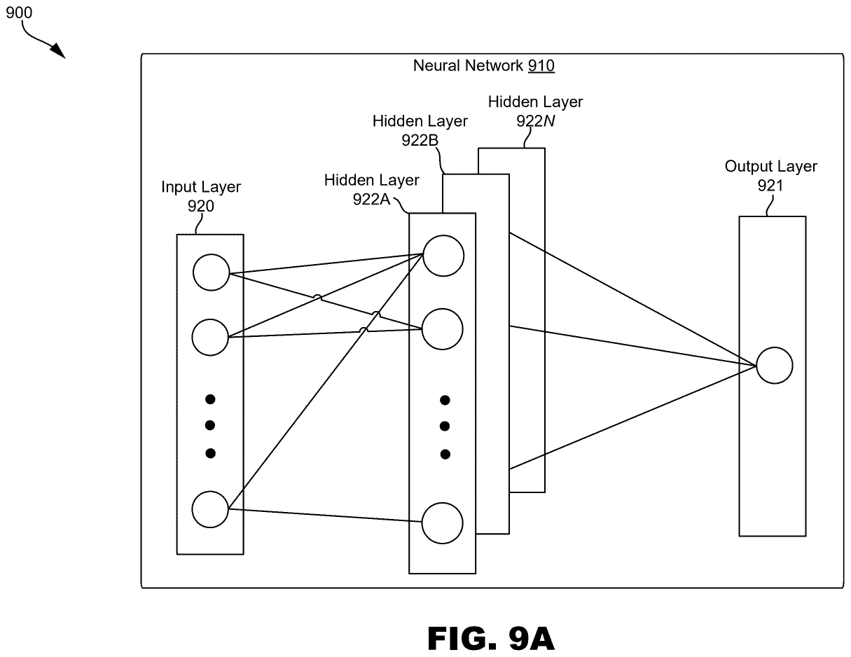

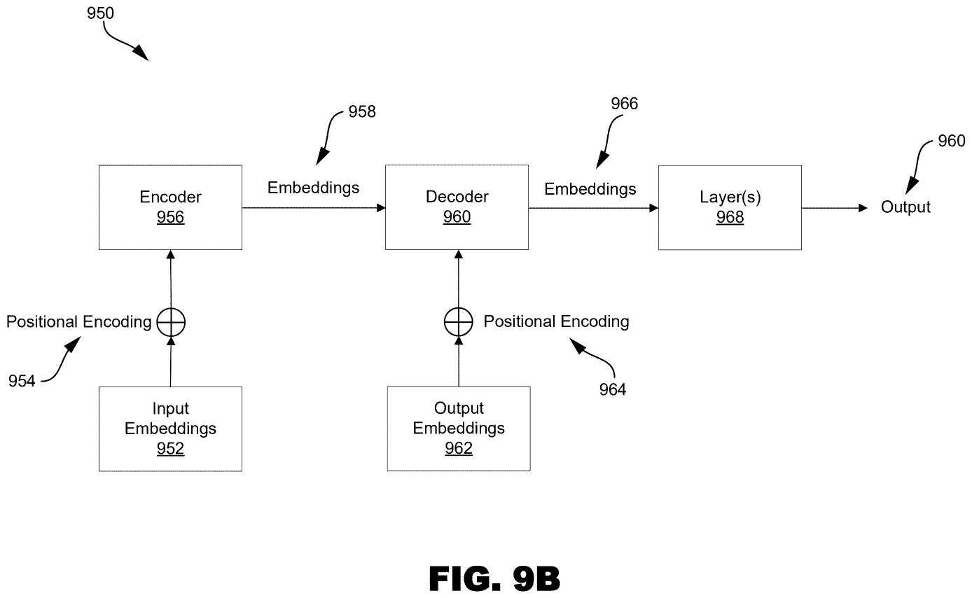

FIG. 9A is a diagram illustrating an example architecture 900 of an example neural network 910. The example architecture 900 of the neural network 910 can be used to implement any AI/ML model described herein and/or any components described herein that can include or implement a neural network. For example, the neural network 910 and/or the architecture 900 of the neural network 910 can be used to implement the Agentic AI system 130, the coordinator 132, any of the domain-specific agents 134, and/or the verifier(s) 136.

The architecture 900 of the neural network 910 can include an input layer 920 that can be configured to receive and process data to generate one or more outputs. The architecture 900 of the neural network 910 can also include hidden layers 922a, 922b, through 922n. The hidden layers 922a, 922b, through 922n include “n” number of hidden layers, where “n” is an integer greater than or equal to one. The number of hidden layers can be made to include as many layers as needed for the given application. The architecture 900 of the neural network 910 can further include an output layer 921 that provides an output resulting from the processing performed by the hidden layers 922a, 922b, through 922n.

The neural network 910 is a multi-layer neural network of interconnected nodes. Each node can represent a piece of information. Information associated with the nodes is shared among the different layers and each layer retains information as information is processed. In some cases, the neural network 910 can include a feed-forward network, in which case there are no feedback connections where outputs of the network are fed back into itself. In some cases, the neural network 910 can include a recurrent neural network, which can have loops that allow information to be carried across nodes while reading in input.

Information can be exchanged between nodes through node-to-node interconnections between the various layers. Nodes of the input layer 920 can activate a set of nodes in the first hidden layer 922a. For example, as shown, each of the input nodes of the input layer 920 is connected to each of the nodes of the first hidden layer 922a. The nodes of the first hidden layer 922a can transform the information of each input node by applying activation functions to the input node information. The information derived from the transformation can then be passed to and can activate the nodes of the next hidden layer 922b, which can perform their own designated functions. Example functions include convolutional, up-sampling, data transformation, and/or any other suitable functions. The output of the hidden layer 922b can then activate nodes of the next hidden layer, and so on. The output of the last hidden layer 922n can activate one or more nodes of the output layer 921, at which an output is provided. In some cases, while nodes in the neural network 910 are shown as having multiple output lines, a node can have a single output and all lines shown as being output from a node represent the same output value.

In some cases, each node or interconnection between nodes can have a weight that is a set of parameters derived from the training of the neural network 910. Once the neural network 910 is trained, it can be referred to as a trained neural network, which can be used to generate one or more outputs. For example, an interconnection between nodes can represent a piece of information learned about the interconnected nodes. The interconnection can have a tunable numeric weight that can be tuned (e.g., based on a training dataset), allowing the neural network 910 to be adaptive to inputs and able to learn as more and more data is processed.

The neural network 910 is pre-trained to process the features from the data in the input layer 920 using the different hidden layers 922a, 922b, through 922n in order to provide the output through the output layer 921.

In some cases, the neural network 910 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 910 is trained well enough so that the weights of the layers are accurately tuned.

To perform training, a loss function can be used to analyze an error in the output. Any suitable loss function definition can be used, such as a Cross-Entropy loss. Another example of a loss function includes the mean squared error (MSE), defined as E_total=Σ(½(target-output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 910 can perform a backward pass by determining which inputs (weights) most contributed to the loss of the network and can adjust the weights so that the loss decreases and is eventually minimized.

The neural network 910 can include any suitable deep network. One example neural network includes a transformer network, which can be used to implement a large language model or any other model. Another example neural network includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 910 can include any other deep network other than a transformer or CNN, such as a encoder-decoder network, an encoder-only network, a decoder-only network, a mixture of experts (MoE) network, a generative model network, an autoencoder, Deep Belief Nets (DBNs), Recurrent Neural Networks (RNNs), among others.

As understood by those of skill in the art, machine-learning based techniques can vary depending on the desired implementation. For example, machine-learning schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

FIG. 9B is a diagram illustrating an example architecture of an example transformer model 950, according to some examples of the present disclosure. The transformer model 950 can be used to implement any AI models/agents described herein such as the agentic AI system 130, the coordinator 132, any of the domain-specific agents 134, and/or the verifier(s) 136. In some cases, the transformer model 950 can be used to implement an LLM for any of the AI agents described herein. As shown, the transformer model 950 can include input embeddings 952 used as inputs to the transformer model 950. The input embeddings 952 can include input values, numbers, vectors, and/or other values representing data such as text (e.g., words, sentences, etc.), speech (e.g., verbal utterances, etc.), image data, domain information, etc.

For example, in a text processing or NLU/NLP use case, the input embeddings 952 can function like a dictionary that helps the transformer model 950 understand the meaning of words by placing them in an embedding space where similar words are located near each other. As another example, the input embeddings 952 can represent a domain of a computer task and domains of the domain-specific agents 134 that the transformer model 950 can compare to match the domain of the computer task with a domain of a domain-specific agent. The transformer model 950 can place the input embeddings 952 representing domains in an embedding space where similar domains are located near each other.

In some examples, the coordinator 132 can be trained and/or configured to create the input embeddings 952 so that similar vectors represent similar domains. For example, the coordinator 132 can be trained and/or configured to create the input embeddings 952 based on the domain of a computer task and the domains of the domain-specific agents 134. In some examples, the transformer model 950 can additionally or alternatively learn to create and/or process the input embeddings 952 during training.

The transformer model 950 can use positional encoding 954 to encode the position of each feature in the input embeddings 952 (or in a sequence in the input embeddings 952) as values such as a set of numbers, a vector, etc. The values generated by the positional encoding 954 can be fed into the transformer model 950 along with the input embeddings 952. By incorporating the positional encoding 954 into the transformer model 950, the transformer model 950 can more effectively understand the input data. For example, in a text processing and/or NLP/NLU context, incorporating the positional encoding 954 into the transformer model 950 can allow the transformer model 950 to more effectively understand the order of words in a sentence and generate grammatically correct and semantically meaningful output.

The transformer model 950 can include an encoder(s) 956 used to process the positionally encoded input embeddings 952 and generate embeddings 958. The encoder(s) 956 can be part of the transformer model 950 that processes inputs and generates hidden states that capture information about the inputs. For example, the encoder(s) 956 can include a feed-forward neural network that is part of the transformer model 950. In some examples, the encoder(s) 956 can implement multiple encoder layers. In some cases, the encoder(s) 956 can first tokenize the input data into tokens or a sequence of tokens, such as individual words or subwords. The encoder(s) 956 can apply one or more self-attention layers, which can generate hidden states that represent the input at different levels of abstraction. In this way, the encoder(s) 956 can generate the embeddings 958 (e.g., a vector, a set of values, etc.) representing information about the inputs, such as, in a text processing or NLP/NLU example, the semantics and position of words in one or more sentences.

The transformer model 950 can include output embeddings 962, which can include values representing information, such as numbers or vectors representing information, such as domains, speech units (e.g., words, sentences, etc.), etc. The output embeddings 962 can be similar to the input embeddings 952 and can also be processed by positional encoding 964 to encode information about a feature or component of an input or the output embeddings 962, such as encoding the position of each word in a sequence from the output embeddings 962 as values such as a set of numbers, a vector, etc., which helps the transformer model 950 understand the order of words in a sentence, or encoding a feature of a domain from the output embeddings 962 as values (e.g., numbers, vectors, etc.) that help the transformer model 950 understand the domains or similarity of domains. The output embeddings 962 can be used during a training phase of the transformer model 950 and can be used during an inference phase. During training, a loss function can be computed based on the output embeddings 962 and used to update the model parameters to improve the accuracy of the transformer model 950. During an inference phase, the output embeddings 962 can be used to generate the output data by mapping the predicted probabilities determined by the transformer model 950 for each token to a corresponding token a model such as a dictionary, a domain dictionary or catalog, etc.

The positionally encoded input embeddings 952 (e.g., the embeddings 958) and the positionally encoded output embeddings 962 can be fed to a decoder(s) 960 used to generate the output based on the encoded input. During training, the decoder(s) 960 can learn how to predict information. For example, in a text processing or NLP/NLU context, during training, the decoder(s) 960 can learn to guess the next word of a sequence by looking at the words before it. In such examples, the decoder(s) 960 can generate natural language text based on an input sequence and any learned context. In other examples, the decoder(s) 960 can generate mappings or confidence scores for domains of domain-specific agents indicating a matching confidence or amount between a domain associated with a computer task and respective domains of the domain-specific agents 134.

The decoder(s) 960 can generate embeddings 966 and feed the embeddings 966 to one or more network layers 968. In some examples, the one or more network layers 968 can include a linear layer and a softmax function. The linear layer can map the embeddings 966 generated by the decoder(s) 960 to a higher-dimensional space, which can transform the embeddings 966 into the original input space. The softmax function can then be applied to generate a probability for each output token, which can result in an output 970. For example, the softmax function can be applied to generate a probability of a distribution for each output token in a vocabulary, which can result in an output 970. In some examples, the output 970 can include output tokens with probabilities. In some cases, the output 970 can additionally or alternatively include domains with confidence scores, correlations, or probabilities.

### Example Computer System

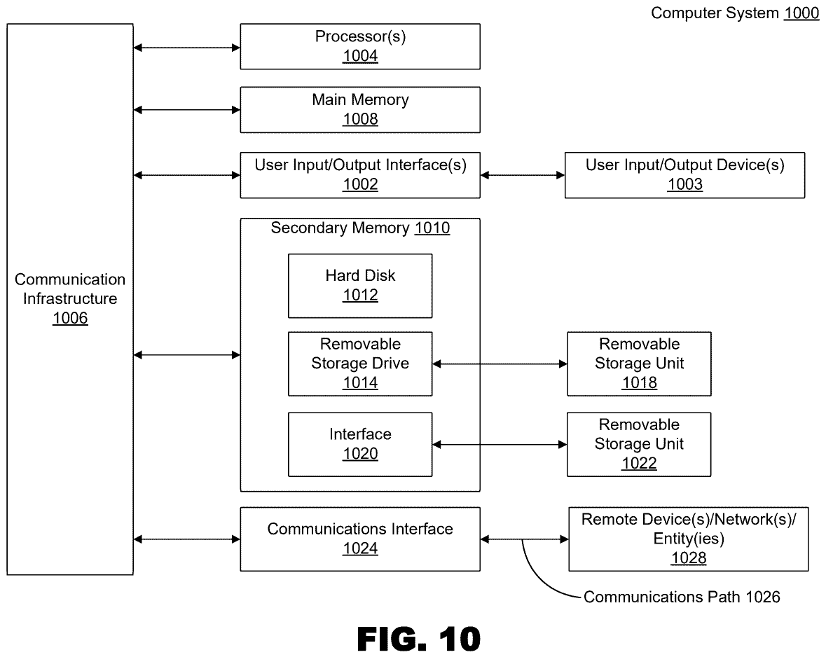

Various aspects and examples may be implemented, for example, using one or more well-known computer systems, such as computer system 1000 shown in FIG. 10. For example, the media device(s) 106, the display device(s) 108, the content server(s) 120, the system servers 128, the agentic AI system 130, and/or any other system may be implemented using computer system 1000 or combinations or sub-combinations of computer system 1000. Also or alternatively, computer system 1000 may be used, for example, to implement any of the aspects and examples discussed herein, as well as combinations and sub-combinations thereof.

Computer system 1000 may include one or more processors (e.g., central processing units or CPUs), such as processor(s) 1004. Processor(s) 1004 may be connected to a communication infrastructure 1006 (or communication bus).

Computer system 1000 may also include user input/output device(s) 1003, such as monitors, keyboards, pointing devices, etc., which may communicate with communication infrastructure 1006 through user input/output interface(s) 1002.

In some examples, the processor(s) 1004 may include one or more graphics processing units (GPUs). In some examples, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc. In other examples, the processor(s) 1004 may additionally or alternatively include or be part of a digital signal processor (DSP), an image signal processor (ISP), an application-specific integrated circuit (ASIC), a field-programmable gate array (FPGA), an integrated circuit, a microcontroller, and/or any other processing device.

Computer system 1000 may also include a main or primary memory 1008, such as random access memory (RAM). Main memory 1008 may include one or more levels of cache. Main memory 1008 may have stored therein control logic (e.g., computer software) and/or data.

Computer system 1000 may also include one or more secondary storage devices or memory 1010. Secondary memory 1010 may include, for example, a hard disk drive 1012 and/or a removable storage device or drive 1014. Removable storage drive 1014 may be a floppy disk drive, a magnetic tape drive, a compact disk drive, an optical storage device, tape backup device, and/or any other storage device/drive.

Removable storage drive 1014 may interact with a removable storage unit 1018. Removable storage unit 1018 may include a computer usable or readable storage device having stored thereon computer software (control logic) and/or data. Removable storage unit 1018 may be a floppy disk, magnetic tape, compact disk, DVD, optical storage disk, and/any other computer data storage device. Removable storage drive 1014 may read from and/or write to removable storage unit 1018.

Secondary memory 1010 may include other means, devices, components, instrumentalities or other approaches for allowing computer programs and/or other instructions and/or data to be accessed by computer system 1000. Such means, devices, components, instrumentalities or other approaches may include, for example, a removable storage unit 1022 and an interface 1020. Examples of the removable storage unit 1022 and the interface 1020 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 1000 may include a communication or network interface 1024. Communication interface 1024 may enable computer system 1000 to communicate and interact with any combination of external devices, external networks, external entities, etc. (individually and collectively referenced by reference number 1028). For example, communication interface 1024 may allow computer system 1000 to communicate with external or remote devices/network/entities 1028 over communications path 1026, which may be wired and/or wireless (or a combination thereof), and which may include any combination of LANs, WANs, the Internet, etc. Control logic and/or data may be transmitted to and from computer system 1000 via communication path 1026.

Computer system 1000 may also be any of a personal digital assistant (PDA), desktop workstation, laptop or notebook computer, netbook, tablet, mobile phone (e.g., smartphone), smart watch or other wearable, appliance, part of the Internet-of-Things, and/or embedded system, to name a few non-limiting examples, or any combination thereof.

Computer system 1000 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1000 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some examples, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1000, main memory 1008, secondary memory 1010, and removable storage units 1018 and 1022, as well as tangible articles of manufacture embodying any combination of the foregoing. Such control logic, when executed by one or more data processing devices (such as computer system 1000 or processor(s) 1004), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 10. In particular, embodiments can operate with software, hardware, and/or operating system implementations other than those described herein.

### Conclusion

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A system comprising: memory; and one or more processors are coupled to the memory and configured to perform operations comprising: determining a domain of a computer task selected for automation; assigning, by a coordinator agent comprising a first artificial intelligence (AI) model, the computer task to a domain-specific agent selected by the coordinator agent from a set of domain-specific agents based on the domain of the computer task and respective domains of the set of domain-specific agents, wherein each of the set of domain-specific agents comprises a different AI model trained or customized for a specific domain from the respective domains; triggering the domain-specific agent to perform the computer task and generate an associated output; and determining, by a verifier agent, an accuracy of the associated output generated by the domain-specific agent, wherein the verifier agent comprises a second AI model trained or customized to determine respective accuracies of outputs generated by the set of domain-specific agents.

Aspect 2. The system of Aspect 1, wherein the one or more processors are configured to perform operations further comprising: obtaining, from one or more data sources, data associated with the computer task; and verifying, by the domain-specific agent and/or the verifier agent, the associated output based on the data associated with the computer task.

Aspect 3. The system of any of Aspects 1 to 2, wherein the coordinator agent is trained or customized to identify specific domains associated with computer tasks and assign the computer tasks to domain-specific agents selected from the set of domain-specific agents based on the respective domains of the set of domain-specific agents and the specific domains associated with the computer tasks.

Aspect 4. The system of Aspect 3, wherein the coordinator agent is trained to learn information associated with the respective domains of the set of domain-specific agents, capabilities associated with the respective domains of the set of domain-specific agents, an end-to-end process of an entity associated with the computer task, information about operations of the entity, information about systems of the entity, and/or information about the entity.

Aspect 5. The system of any of Aspects 1 to 4, wherein the respective domains comprise language translation, data deduplication, content recommendation, text processing, image processing, computer vision, validating content from a provider based on a document identifying what content the provider has agreed to deliver to an entity, quality control of metadata associated with the content from the provider, validating covers or artwork of the content delivered by the provider, detecting or correcting errors in one or more content pipelines associated with the entity, monitoring a health of one or more systems associated the entity, and/or determining an updated configuration of a content recommendation platform.

Aspect 6. The system of any of Aspects 1 to 5, wherein determining the accuracy of the associated output generated by the domain-specific agent comprises validating the associated output, detecting one or more errors in the associated output, and/or determining a confidence score for the associated output, wherein the confidence score represents a likelihood that the associated output is accurate or complies with one or more requirements.

Aspect 7. The system of any of Aspects 1 to 6, wherein determining the accuracy of the associated output generated by the domain-specific agent comprises detecting one or more errors in the associated output, and wherein the one or more processors are configured to perform operations further comprising: determining, by the verifier agent and/or the domain-specific agent, how to correct the one or more errors in the associated output; and correcting, by the verifier agent and/or the domain-specific agent, the one or more errors in the associated output.

Aspect 8. The system of any of Aspects 1 to 7, wherein determining the domain of the computer task comprises: determining, by the coordinator agent, information about the computer task, the information about the computer task comprising a type of operation associated with the computer task, a topic associated with the computer task, a field or category associated with the computer task, a capability needed to perform the computer task, a type of data associated with the computer task, a type of output associated with the computer task, an action associated with the computer task, an attribute of the computer task, a task type of the computer task, and/or a subject area associated with the computer task and/or information associated with the computer task; and determining, by the coordinator agent, the domain of the computer task based on the information about the computer task.

Aspect 9. The system of Aspect 8, wherein assigning the computer task to the domain-specific agent comprises: determining, by the coordinator agent, the respective domains of the set of domain-specific agents; based on a comparison of the domain of the computer task and each of the respective domains, selecting, by the coordinator agent, the domain-specific agent for the computer task; and routing, by the coordinator agent, the computer task to the domain-specific agent.

Aspect 10. The system of Aspect 9, wherein the domain-specific agent is selected for the computer task further based on respective correspondence scores between the domain of the computer task and the respective domains of the set of domain-specific agents, the respective correspondence scores representing respective matches between the domain and the respective domains, respective similarities between the domain and the respective domains, respective relevances between the domain and the respective domains, respective distances calculated for the domain and the respective domains, respective overlaps between the domain and the respective domains, respective relationships between the domain and the respective domains, and/or respective confidences between the domain and the respective domains.

Aspect 11. A computer-implemented method comprising: determining a domain of a computer task selected for automation; assigning, by a coordinator agent comprising a first artificial intelligence (AI) model, the computer task to a domain-specific agent selected by the coordinator agent from a set of domain-specific agents based on the domain of the computer task and respective domains of the set of domain-specific agents, wherein each of the set of domain-specific agents comprises a different AI model trained or customized for a specific domain from the respective domains; triggering the domain-specific agent to perform the computer task and generate an associated output; and determining, by a verifier agent, an accuracy of the associated output generated by the domain-specific agent, wherein the verifier agent comprises a second AI model trained or customized to determine respective accuracies of outputs generated by the set of domain-specific agents.

Aspect 12. The computer-implemented method of Aspect 11, further comprising: obtaining, from one or more data sources, data associated with the computer task; and verifying, by the domain-specific agent and/or the verifier agent, the associated output based on the data associated with the computer task.

Aspect 13. The computer-implemented method of any of Aspects 11 to 12, wherein the coordinator agent is trained or customized to identify specific domains associated with computer tasks and assign the computer tasks to domain-specific agents selected from the set of domain-specific agents based on the respective domains of the set of domain-specific agents and the specific domains associated with the computer tasks.

Aspect 14. The computer-implemented method of Aspect 13, wherein the coordinator agent is trained to learn information associated with the respective domains of the set of domain-specific agents, capabilities associated with the respective domains of the set of domain-specific agents, an end-to-end process of an entity associated with the computer task, information about operations of the entity, information about systems of the entity, and/or information about the entity.

Aspect 15. The computer-implemented method of any of Aspects 11 to 14, wherein the respective domains comprise language translation, data deduplication, content recommendation, text processing, image processing, computer vision, validating content from a provider based on a document identifying what content the provider has agreed to deliver to an entity, quality control of metadata associated with the content from the provider, validating covers or artwork of the content delivered by the provider, detecting or correcting errors in one or more content pipelines associated with the entity, monitoring a health of one or more systems associated the entity, and/or determining an updated configuration of a content recommendation platform.

Aspect 16. The computer-implemented method of any of Aspects 11 to 15, wherein determining the accuracy of the associated output generated by the domain-specific agent comprises validating the associated output, detecting one or more errors in the associated output, and/or determining a confidence score for the associated output, wherein the confidence score represents a likelihood that the associated output is accurate or complies with one or more requirements.

Aspect 17. The computer-implemented method of any of Aspects 11 to 16, wherein determining the accuracy of the associated output generated by the domain-specific agent comprises detecting one or more errors in the associated output, the computer-implemented method further comprising: determining, by the verifier agent and/or the domain-specific agent, how to correct the one or more errors in the associated output; and correcting, by the verifier agent and/or the domain-specific agent, the one or more errors in the associated output.

Aspect 18. The computer-implemented method of any of Aspects 11 to 17, wherein determining the domain of the computer task comprises: determining, by the coordinator agent, information about the computer task, the information about the computer task comprising a type of operation associated with the computer task, a topic associated with the computer task, a field or category associated with the computer task, a capability needed to perform the computer task, a type of data associated with the computer task, a type of output associated with the computer task, an action associated with the computer task, an attribute of the computer task, a task type of the computer task, and/or a subject area associated with the computer task and/or information associated with the computer task; and determining, by the coordinator agent, the domain of the computer task based on the information about the computer task.

Aspect 19. The computer-implemented method of Aspect 18, wherein assigning the computer task to the domain-specific agent comprises: determining, by the coordinator agent, the respective domains of the set of domain-specific agents; selecting, by the coordinator agent, the domain-specific agent for the computer task based on a comparison of the domain of the computer task and each of the respective domains; and routing, by the coordinator agent, the computer task to the domain-specific agent.

Aspect 20. The computer-implemented method of Aspect 19, wherein the domain-specific agent is selected for the computer task further based on respective correspondence scores between the domain of the computer task and the respective domains of the set of domain-specific agents, the respective correspondence scores representing respective matches between the domain and the respective domains, respective similarities between the domain and the respective domains, respective relevances between the domain and the respective domains, respective distances calculated for the domain and the respective domains, respective overlaps between the domain and the respective domains, respective relationships between the domain and the respective domains, and/or respective confidences between the domain and the respective domains.

Aspect 21. The computer-implemented method of any of Aspects 11 to 20, further comprising training the coordinator agent to learn information associated with the respective domains of the set of domain-specific agents, capabilities associated with the respective domains of the set of domain-specific agents, an end-to-end process of an entity associated with the computer task, information about operations of the entity, information about systems of the entity, and/or information about the entity.

Aspect 22. The computer-implemented method of Aspect 21, wherein training the coordinator agent to learn information associated with the respective domains, capabilities associated with the respective domains, an end-to-end process of the entity, information about operations of the entity, information about systems of the entity, and/or information about the entity comprises: triggering an AI model of the coordinator agent to process training data and generate outputs based on the training data; calculating errors or loss values associated with the outputs; and adjusting one or more parameters of the AI model based on the errors or loss values associated with the outputs.

Aspect 23. The computer-implemented method of any of Aspects 11 to 22, further comprising training each domain-specific agent to learn information from a corresponding domain of the respective domains, capabilities associated with the corresponding domain, a process associated with the corresponding domain, functionalities associated with the corresponding domain, operations associated with the corresponding domain, attributes associated with the corresponding domain, capabilities to process data associated with the corresponding domain, capabilities to generate outputs associated with the corresponding domain, and/or capabilities to make decisions associated with the corresponding domain.

Aspect 24. The computer-implemented method of Aspect 23, wherein training each domain-specific agent comprises: triggering a respective AI model of each domain-specific agent to process respective training data and generate respective outputs based on the respective training data; calculating respective errors or loss values associated with the respective outputs; and adjusting one or more parameters of the respective AI model based on the respective errors or loss values associated with the respective outputs.

Aspect 25. The computer-implemented method of any of Aspects 11 to 24, further comprising training the verifier agent to learn information from one or more domains, capabilities associated with the one or more domains, one or more processes associated with the one or more domains, functionalities associated with the one or more domains, operations associated with the one or more domains, attributes associated with the one or more domains, capabilities to process data associated with the one or more domains, capabilities to generate outputs associated with the one or more domains, and/or capabilities to make decisions associated with the c one or more domains.

Aspect 26. The computer-implemented method of Aspect 25, wherein training the verifier agent comprises: triggering an AI model of the verifier agent to process training data and generate outputs based on the training data; calculating errors or loss values associated with the outputs; and adjusting one or more parameters of the AI model based on the errors or loss values associated with the outputs.

Aspect 27. A non-transitory computer-readable medium having instructions stored thereon that, when executed by one or more processors, cause the one or more processors to perform a method according to any of Aspects 11 to 26.

Aspect 28. A system comprising means for performing a method according to any of Aspects 11 to 26.

What is claimed is:

1. A system comprising:
memory; and
one or more processors are coupled to the memory and configured to perform operations comprising:
determining a domain of a computer task selected for automation;
assigning, by a coordinator agent comprising a first artificial intelligence (AI) model, the computer task to a domain-specific agent selected by the coordinator agent from a set of domain-specific agents based on the domain of the computer task and respective domains of the set of domain-specific agents, wherein each of the set of domain-specific agents comprises a different AI model trained or customized for a specific domain from the respective domains;
triggering the domain-specific agent to perform the computer task and generate an associated output; and
determining, by a verifier agent, an accuracy of the associated output generated by the domain-specific agent, wherein the verifier agent comprises a second AI model trained or customized to determine respective accuracies of outputs generated by the set of domain-specific agents.

2. The system of claim 1, wherein the one or more processors are configured to perform operations further comprising:
obtaining, from one or more data sources, data associated with the computer task; and
verifying, by at least one of the domain-specific agent and the verifier agent, the associated output based on the data associated with the computer task.

3. The system of claim 1, wherein the coordinator agent is trained or customized to identify specific domains associated with computer tasks and assign the computer tasks to domain-specific agents selected from the set of domain-specific agents based on the respective domains of the set of domain-specific agents and the specific domains associated with the computer tasks.

4. The system of claim 3, wherein the coordinator agent is trained to learn at least one of information associated with the respective domains of the set of domain-specific agents, capabilities associated with the respective domains of the set of domain-specific agents, an end-to-end process of an entity associated with the computer task, information about operations of the entity, information about systems of the entity, and information about the entity.

5. The system of claim 1, wherein the respective domains comprise at least one of language translation, data deduplication, content recommendation, text processing, image processing, computer vision, validating content from a provider based on a document identifying what content the provider has agreed to deliver to an entity, quality control of metadata associated with the content from the provider, validating covers or artwork of the content delivered by the provider, detecting or correcting errors in one or more content pipelines associated with the entity, monitoring a health of one or more systems associated the entity, and determining an updated configuration of a content recommendation platform.

6. The system of claim 1, wherein determining the accuracy of the associated output generated by the domain-specific agent comprises at least one of validating the associated output, detecting one or more errors in the associated output, and determining a confidence score for the associated output, wherein the confidence score represents a likelihood that the associated output is accurate or complies with one or more requirements.

7. The system of claim 1, wherein determining the accuracy of the associated output generated by the domain-specific agent comprises detecting one or more errors in the associated output, and wherein the one or more processors are configured to perform operations further comprising:
determining, by at least one of the verifier agent and the domain-specific agent, how to correct the one or more errors in the associated output; and
correcting, by at least one of the verifier agent and the domain-specific agent, the one or more errors in the associated output.

8. The system of claim 1, wherein determining the domain of the computer task comprises:
determining, by the coordinator agent, information about the computer task, the information about the computer task comprising at least one of a type of operation associated with the computer task, a topic associated with the computer task, a field or category associated with the computer task, a capability needed to perform the computer task, a type of data associated with the computer task, a type of output associated with the computer task, an action associated with the computer task, an attribute of the computer task, a task type of the computer task, and a subject area associated with at least one of the computer task and information associated with the computer task; and
determining, by the coordinator agent, the domain of the computer task based on the information about the computer task.

9. The system of claim 8, wherein assigning the computer task to the domain-specific agent comprises:
determining, by the coordinator agent, the respective domains of the set of domain-specific agents;
based on a comparison of the domain of the computer task and each of the respective domains, selecting, by the coordinator agent, the domain-specific agent for the computer task; and
routing, by the coordinator agent, the computer task to the domain-specific agent.

10. The system of claim 9, wherein the domain-specific agent is selected for the computer task further based on respective correspondence scores between the domain of the computer task and the respective domains of the set of domain-specific agents, the respective correspondence scores representing at least one of respective matches between the domain and the respective domains, respective similarities between the domain and the respective domains, respective relevances between the domain and the respective domains, respective distances calculated for the domain and the respective domains, respective overlaps between the domain and the respective domains, respective relationships between the domain and the respective domains, and respective confidences between the domain and the respective domains.

11. A computer-implemented method comprising:
determining a domain of a computer task selected for automation;
assigning, by a coordinator agent comprising a first artificial intelligence (AI) model, the computer task to a domain-specific agent selected by the coordinator agent from a set of domain-specific agents based on the domain of the computer task and respective domains of the set of domain-specific agents, wherein each of the set of domain-specific agents comprises a different AI model trained or customized for a specific domain from the respective domains;
triggering the domain-specific agent to perform the computer task and generate an associated output; and
determining, by a verifier agent, an accuracy of the associated output generated by the domain-specific agent, wherein the verifier agent comprises a second AI model trained or customized to determine respective accuracies of outputs generated by the set of domain-specific agents.

12. The computer-implemented method of claim 11, further comprising:
obtaining, from one or more data sources, data associated with the computer task; and
verifying, by at least one of the domain-specific agent and the verifier agent, the associated output based on the data associated with the computer task.

13. The computer-implemented method of claim 11, wherein the coordinator agent is trained or customized to identify specific domains associated with computer tasks and assign the computer tasks to domain-specific agents selected from the set of domain-specific agents based on the respective domains of the set of domain-specific agents and the specific domains associated with the computer tasks.

14. The computer-implemented method of claim 13, wherein the coordinator agent is trained to learn at least one of information associated with the respective domains of the set of domain-specific agents, capabilities associated with the respective domains of the set of domain-specific agents, an end-to-end process of an entity associated with the computer task, information about operations of the entity, information about systems of the entity, and information about the entity.

15. The computer-implemented method of claim 11, wherein the respective domains comprise at least one of language translation, data deduplication, content recommendation, text processing, image processing, computer vision, validating content from a provider based on a document identifying what content the provider has agreed to deliver to an entity, quality control of metadata associated with the content from the provider, validating covers or artwork of the content delivered by the provider, detecting or correcting errors in one or more content pipelines associated with the entity, monitoring a health of one or more systems associated the entity, and determining an updated configuration of a content recommendation platform.

16. The computer-implemented method of claim 11, wherein determining the accuracy of the associated output generated by the domain-specific agent comprises at least one of validating the associated output, detecting one or more errors in the associated output, and determining a confidence score for the associated output, wherein the confidence score represents a likelihood that the associated output is accurate or complies with one or more requirements.

17. The computer-implemented method of claim 11, wherein determining the accuracy of the associated output generated by the domain-specific agent comprises detecting one or more errors in the associated output, the computer-implemented method further comprising:
determining, by at least one of the verifier agent and the domain-specific agent, how to correct the one or more errors in the associated output; and
correcting, by at least one of the verifier agent and the domain-specific agent, the one or more errors in the associated output.

18. The computer-implemented method of claim 11, wherein determining the domain of the computer task comprises:
determining, by the coordinator agent, information about the computer task, the information about the computer task comprising at least one of a type of operation associated with the computer task, a topic associated with the computer task, a field or category associated with the computer task, a capability needed to perform the computer task, a type of data associated with the computer task, a type of output associated with the computer task, an action associated with the computer task, an attribute of the computer task, a task type of the computer task, and a subject area associated with at least one of the computer task and information associated with the computer task; and
determining, by the coordinator agent, the domain of the computer task based on the information about the computer task.

19. The computer-implemented method of claim 18, wherein assigning the computer task to the domain-specific agent comprises:
determining, by the coordinator agent, the respective domains of the set of domain-specific agents;
selecting, by the coordinator agent, the domain-specific agent for the computer task based on at least one of a comparison of the domain of the computer task and each of the respective domains and respective correspondence scores between the domain of the computer task and the respective domains, the respective correspondence scores representing at least one of respective matches between the domain and the respective domains, respective similarities between the domain and the respective domains, a respective relevance of the domain with respect to each of the respective domains, and respective distances calculated for the domain and the respective domains; and
routing, by the coordinator agent, the computer task to the domain-specific agent.

20. A non-transitory computer-readable medium having instructions stored thereon that, when executed by one or more processors, cause the one or more processors to perform operations comprising:
determining a domain of a computer task selected for automation;
assigning, by a coordinator agent comprising a first artificial intelligence (AI) model, the computer task to a domain-specific agent selected by the coordinator agent from a set of domain-specific agents based on the domain of the computer task and respective domains of the set of domain-specific agents, wherein each of the set of domain-specific agents comprises a different AI model trained or customized for a specific domain from the respective domains;
triggering the domain-specific agent to perform the computer task and generate an associated output; and
determining, by a verifier agent, an accuracy of the associated output generated by the domain-specific agent, wherein the verifier agent comprises a second AI model trained or customized to determine respective accuracies of outputs generated by the set of domain-specific agents.
